(19) United States
(12) Patent Application Publication
(10) Pub. No.: US 2023/0388752 A1
(43) Pub. Date: Nov. 30, 2023

(54) TARGETED MULTICAST BROADCAST SERVICES (MBS) NOTIFICATION SIGNALING

(71) Applicant: TOYOTA JIDOSHA KABUSHIKI KAISHA, Toyota-shi, Aichi-ken (JP)

(72) Inventor: Alireza BABAEI, Fairfax, VA (US)

(73) Assignee: TOYOTA JIDOSHA KABUSHIKI KAISHA, Toyota-shi, Aichi-ken (JP)

(21) Appl. No.: 18/029,720

(22) PCT Filed: Dec. 6, 2021
(86) PCT No.: PCT/JP2021/044717

§ 371 Date: Mar. 31, 2023

Related U.S. Application Data
(60) Provisional application No. 63/122,643, filed on Dec. 8, 2020.

(51) Int. Cl. H04W 4/06; H04W 68/02

(52) U.S. Cl. CPC H04W 4/06; H04W 68/02; H04L 12/189

(57) ABSTRACT

A system, method and apparatus for wireless communications is provided. A user equipment (UE) receives downlink control information (DCI) associated with a first radio network temporary identifier (RNTI) and used for scheduling paging information. The at least one of the first RNTI and the DCI indicates that the paging information, scheduled by the DCI, is associated with a first MBS service. The UE then receives MBS data based on the paging information.

### TECHNICAL FIELD

The disclosure relates to a method of paging for multicast and broadcast services (MBS) data transmission.

### BACKGROUND ART

Generally described, computing devices and communication networks can be utilized to exchange information. In a common application, a computing device can request/transmit data with another computing device via the communication network. More specifically, computing devices may utilize a wireless communication network to exchange information or establish communication channels.

Wireless communication networks can include a wide variety of devices that include or access components to access a wireless communication network. Such devices can utilize the wireless communication network to facilitate interactions with other devices that can access the wireless communication network or to facilitate interaction, through the wireless communication network, with devices utilizing other communication networks.

### SUMMARY OF INVENTION

In some embodiments of this disclosure, a method of paging for multicast and broadcast services (MBS) data transmission is provided. The method includes: receiving, by a user equipment (UE), downlink control information (DCI) associated with a first radio network temporary identifier (RNTI) and used for scheduling paging information, wherein at least one of the first RNTI and the DCI indicates that the paging information, scheduled by the DCI, is associated with a first MBS service; and receiving MBS data based on the paging information.

### BRIEF DESCRIPTION OF DRAWINGS

FIG. 1 shows an example of a system of mobile communications according to some aspects of one or more exemplary embodiments of the present disclosure.

FIG. 2A and FIG. 2B show examples of radio protocol stacks for user plane and control plane, respectively, according to some aspects of one or more exemplary embodiments of the present disclosure.

FIG. 3A, FIG. 3B and FIG. 3C show example mappings between logical channels and transport channels in downlink, uplink and sidelink, respectively, according to some aspects of one or more exemplary embodiments of the present disclosure.

FIG. 4A, FIG. 4B and FIG. 4C show example mappings between transport channels and physical channels in downlink, uplink and sidelink, respectively, according to some aspects of one or more exemplary embodiments of the present disclosure.

FIG. 5A, FIG. 5B, FIG. 5C and FIG. 5D show examples of radio protocol stacks for NR sidelink communication according to some aspects of one or more exemplary embodiments of the present disclosure.

FIG. 6 shows example physical signals in downlink, uplink and sidelink according to some aspects of one or more exemplary embodiments of the present disclosure.

FIG. 7 shows examples of Radio Resource Control (RRC) states and transitioning between different RRC states according to some aspects of one or more exemplary embodiments of the present disclosure.

FIG. 8 shows example frame structure and physical resources according to some aspects of one or more exemplary embodiments of the present disclosure.

FIG. 9 shows example component carrier configurations in different carrier aggregation scenarios according to some aspects of one or more exemplary embodiments of the present disclosure.

FIG. 10 shows example bandwidth part configuration and switching according to some aspects of one or more exemplary embodiments of the present disclosure.

FIG. 11 shows example four-step contention-based and contention-free random access processes according to some aspects of one or more exemplary embodiments of the present disclosure.

FIG. 12 shows example two-step contention-based and contention-free random access processes according to some aspects of one or more exemplary embodiments of the present disclosure.

FIG. 13 shows example time and frequency structure of Synchronization Signal and Physical Broadcast Channel (PBCH) Block (SSB) according to some aspects of one or more exemplary embodiments of the present disclosure.

FIG. 14 shows example SSB burst transmissions according to some aspects of one or more exemplary embodiments of the present disclosure.

FIG. 15 shows example components of a user equipment and a base station for transmission and/or reception according to some aspects of one or more exemplary embodiments of the present disclosure.

FIG. 16 shows an example multicast broadcast service (MBS) interest indication according to some aspects of one or more exemplary embodiments of the present disclosure.

FIG. 17 shows example paging occasions (POs) in a paging frame (PF) according to some aspects of some of various exemplary embodiments of the present disclosure.

FIG. 18 shows an example targeted MBS notification signaling and UE processing according to some aspects of some of various exemplary embodiments of the present disclosure.

FIG. 19A, FIG. 19B, FIG. 19C and FIG. 19D show example processes according to some aspects of some of various exemplary embodiments of the present disclosure.

FIG. 20 shows an example process according to some aspects of some of various exemplary embodiments of the present disclosure.

### DESCRIPTION OF EMBODIMENTS

The following disclosure provides many different embodiments, or examples, for implementing different features of the provided subject matter. Specific examples of arrangements are described below to simplify the present disclosure. These are merely examples and are not intended to be limiting.

Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments.

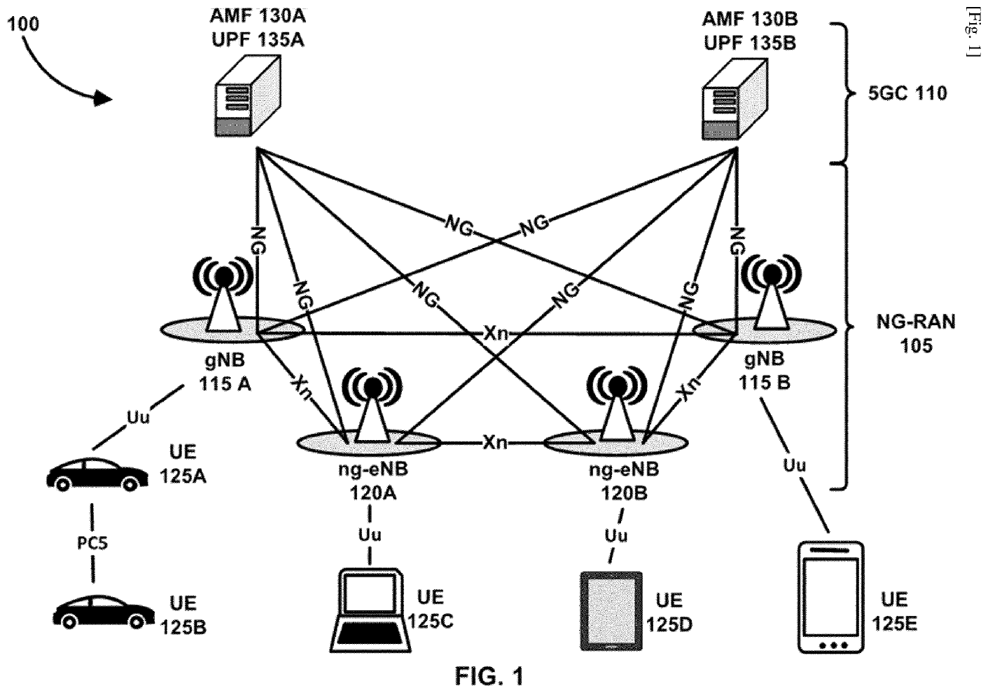

FIG. 1 shows an example of a system of mobile communications 100 according to some aspects of one or more exemplary embodiments of the present disclosure. The system of mobile communication 100 may be operated by a wireless communications system operator such as a Mobile Network Operator (MNO), a private network operator, a Multiple System Operator (MSO), an Internet of Things (IOT) network operator, etc., and may offer services such as voice, data (e.g., wireless Internet access), messaging, vehicular communications services such as Vehicle to Everything (V2X) communications services, safety services, mission critical service, services in residential, commercial or industrial settings such as IoT, industrial IOT (IIOT), etc.

The system of mobile communications 100 may enable various types of applications with different requirements in terms of latency, reliability, throughput, etc. Example supported applications include enhanced Mobile Broadband (eMBB), Ultra-Reliable Low-Latency Communications (URLLC), and massive Machine Type Communications (mMTC). eMBB may support stable connections with high peak data rates, as well as moderate rates for cell-edge users. URLLC may support application with strict requirements in terms of latency and reliability and moderate requirements in terms of data rate. Example mMTC application includes a network of a massive number of IoT devices, which are only sporadically active and send small data payloads.

The system of mobile communications 100 may include a Radio Access Network (RAN) portion and a core network portion. The example shown in FIG. 1 illustrates a Next Generation RAN (NG-RAN) 105 and a 5G Core Network (5GC) 110 as examples of the RAN and core network, respectively. Other examples of RAN and core network may be implemented without departing from the scope of this disclosure. Other examples of RAN include Evolved Universal Terrestrial Radio Access Network (EUTRAN), Universal Terrestrial Radio Access Network (UTRAN), etc. Other examples of core network include Evolved Packet Core (EPC), UMTS Core Network (UCN), etc. The RAN implements a Radio Access Technology (RAT) and resides between User Equipments (UEs) 125 (e.g., UE 125A-UE 125E) and the core network. Examples of such RATs include New Radio (NR), Long Term Evolution (LTE) also known as Evolved Universal Terrestrial Radio Access (EUTRA), Universal Mobile Telecommunication System (UMTS), etc. The RAT of the example system of mobile communications 100 may be NR. The core network resides between the RAN and one or more external networks (e.g., data networks) and is responsible for functions such as mobility management, authentication, session management, setting up bearers and application of different Quality of Services (QoSs). The functional layer between the UEs 125 and the RAN (e.g., the NG-RAN 105) may be referred to as Access Stratum (AS) and the functional layer between the UEs 125 and the core network (e.g., the 5GC 110) may be referred to as Non-access Stratum (NAS).

The UEs 125 may include wireless transmission and reception components for communications with one or more nodes in the RAN, one or more relay nodes, or one or more other UEs, etc. Example of the UEs 125 include, but are not limited to, smartphones, tablets, laptops, computers, wireless transmission and/or reception units in a vehicle, V2X or Vehicle to Vehicle (V2V) devices, wireless sensors, IoT devices, IIOT devices, etc. Other names may be used for the UEs 125 such as a Mobile Station (MS), terminal equipment, terminal node, client device, mobile device, etc. Still further, UEs 125 may also include components or subcomponents integrated into other devices, such as vehicles, to provide wireless communication functionality with nodes in the RAN, other UEs, satellite communications as described herein. Such other devices may have other functionality or multiple functionalities in addition to wireless communications. Accordingly, reference to UE may include the individual components facilitating the wireless communication as well as the entire device that incorporates components for facilitating wireless communications.

The RAN may include nodes (e.g., base stations) for communications with the UEs. For example, the NG-RAN 105 of the system of mobile communications 100 may comprise nodes for communications with the UEs 125. Different names for the RAN nodes may be used, for example depending on the RAT used for the RAN. A RAN node may be referred to as Node B (NB) in a RAN that uses the UMTS RAT. A RAN node may be referred to as an evolved Node B (eNB) in a RAN that uses LTE/EUTRA RAT. For the illustrative example of the system of mobile communications 100 in FIG. 1, the nodes of the NG-RAN 105 may be either a next generation Node B (gNB) 115 (e.g., gNB 115A, gNB 115B) or a next generation evolved Node B (ng-eNB) 120 (e.g., ng-eNB 120A, ng-eNB 120B). In this specification, the terms base station, RAN node, gNB and ng-eNB may be used interchangeably. The gNB 115 may provide NR user plane and control plane protocol terminations towards the UE 125. The ng-eNB 120 may provide E-UTRA user plane and control plane protocol terminations towards the UE 125. An interface between the gNB 115 and the UE 125 or between the ng-eNB 120 and the UE 125 may be referred to as a Uu interface. The Uu interface may be established with a user plane protocol stack and a control plane protocol stack. For a Uu interface, the direction from the base station (e.g., the gNB 115 or the ng-eNB 120) to the UE 125 may be referred to as downlink and the direction from the UE 125 to the base station (e.g., gNB 115 or ng-eNB 120) may be referred to as uplink.

The gNBs 115 and ng-eNBs 120 may be interconnected with each other by means of an Xn interface. The Xn interface may comprise an Xn User plane (Xn-U) interface and an Xn Control plane (Xn-C) interface. The transport network layer of the Xn-U interface may be built on Internet Protocol (IP) transport and General Packet Radio Service (GPRS) Tunneling Protocol (GTP) may be used on top of User Datagram Protocol (UDP)/IP to carry the user plane protocol data units (PDUs). Xn-U may provide non-guaranteed delivery of user plane PDUs and may support data forwarding and flow control. The transport network layer of the Xn-C interface may be built on Stream Control Transport Protocol (SCTP) on top of IP. The application layer signaling protocol may be referred to as XnAP (Xn Application Protocol). The SCTP layer may provide the guaranteed delivery of application layer messages. In the transport IP layer, point-to-point transmission may be used to deliver the signaling PDUs. The Xn-C interface may support Xn interface management, UE mobility management, including context transfer and RAN paging, and dual connectivity.

The gNBs 115 and ng-eNBs 120 may also be connected to the 5GC 110 by means of the NG interfaces, more specifically to an Access and Mobility Management Function (AMF) 130 (e.g., AMF 130A, AMF 130B) of the 5GC 110 by means of the NG-C interface and to a User Plane Function (UPF) 135 (e.g., UPF135A, UPF 135B) of the 5GC 110 by means of the NG-U interface. The transport network layer of the NG-U interface may be built on IP transport and GTP protocol may be used on top of UDP/IP to carry the user plane PDUs between the NG-RAN node (e.g., gNB 115 or ng-eNB 120) and the UPF 135. NG-U may provide non-guaranteed delivery of user plane PDUs between the NG-RAN node and the UPF. The transport network layer of the NG-C interface may be built on IP transport. For the reliable transport of signaling messages, SCTP may be added on top of IP. The application layer signaling protocol may be referred to as NGAP (NG Application Protocol). The SCTP layer may provide guaranteed delivery of application layer messages. In the transport, IP layer pointto-point transmission may be used to deliver the signaling PDUs. The NG-C interface may provide the following functions: NG interface management; UE context management; UE mobility management; transport of NAS messages; paging; PDU Session Management; configuration transfer; and warning message transmission.

The gNB 115 or the ng-eNB 120 may host one or more of the following functions: Radio Resource Management functions such as Radio Bearer Control, Radio Admission Control, Connection Mobility Control, Dynamic allocation of resources to UEs in both uplink and downlink (e.g., scheduling); IP and Ethernet header compression, encryption and integrity protection of data; Selection of an AMF at UE attachment when no routing to an AMF can be determined from the information provided by the UE; Routing of User Plane data towards UPF(s); Routing of Control Plane information towards AMF; Connection setup and release; Scheduling and transmission of paging messages; Scheduling and transmission of system broadcast information (e.g., originated from the AMF); Measurement and measurement reporting configuration for mobility and scheduling; Transport level packet marking in the uplink; Session Management; Support of Network Slicing; QoS Flow management and mapping to data radio bearers; Support of UEs in RRC Inactive state; Distribution function for NAS messages; Radio access network sharing; Dual Connectivity; Tight interworking between NR and E-UTRA; and Maintaining security and radio configuration for User Plane 5G system (5GS) Cellular IoT (CIoT) Optimization.

The AMF 130 may host one or more of the following functions: NAS signaling termination; NAS signaling security; AS Security control; Inter CN node signaling for mobility between 3GPP access networks; Idle mode UE Reachability (including control and execution of paging retransmission); Registration Area management; Support of intra-system and inter-system mobility; Access Authentication; Access Authorization including check of roaming rights; Mobility management control (subscription and policies); Support of Network Slicing; Session Management Function (SMF) selection; Selection of 5GS CIoT optimizations.

The UPF 135 may host one or more of the following functions: Anchor point for Intra-/Inter-RAT mobility (when applicable); External PDU session point of interconnect to Data Network; Packet routing and forwarding; Packet inspection and User plane part of Policy rule enforcement; Traffic usage reporting; Uplink classifier to support routing traffic flows to a data network; Branching point to support multihomed PDU session; QoS handling for user plane, e.g. packet filtering, gating, UL/DL rate enforcement; Uplink Traffic verification (Service Data Flow (SDF) to QoS flow mapping); Downlink packet buffering and downlink data notification triggering.

As shown in FIG. 1, the NG-RAN 105 may support the PC5 interface between two UEs 125 (e.g., UE 125A and UE125B). In the PC5 interface, the direction of communications between two UEs (e.g., from UE 125A to UE 125B or vice versa) may be referred to as sidelink. Sidelink transmission and reception over the PC5 interface may be supported when the UE 125 is inside NG-RAN 105 coverage, irrespective of which RRC state the UE is in, and when the UE 125 is outside NG-RAN 105 coverage. Support of V2X services via the PC5 interface may be provided by NR sidelink communication and/or V2X sidelink communication.

PC5-S signaling may be used for unicast link establishment with Direct Communication Request/Accept message. A UE may self-assign its source Layer-2 ID for the PC5 unicast link for example based on the V2X service type. During unicast link establishment procedure, the UE may send its source Layer-2 ID for the PC5 unicast link to the peer UE, e.g., the UE for which a destination ID has been received from the upper layers. A pair of source Layer-2 ID and destination Layer-2 ID may uniquely identify a unicast link. The receiving UE may verify that the said destination ID belongs to it and may accept the Unicast link establishment request from the source UE. During the PC5 unicast link establishment procedure, a PC5-RRC procedure on the Access Stratum may be invoked for the purpose of UE sidelink context establishment as well as for AS layer configurations, capability exchange etc. PC5-RRC signaling may enable exchanging UE capabilities and AS layer configurations such as Sidelink Radio Bearer configurations between pair of UEs for which a PC5 unicast link is established.

NR sidelink communication may support one of three types of transmission modes (e.g., Unicast transmission, Groupcast transmission, and Broadcast transmission) for a pair of a Source Layer-2 ID and a Destination Layer-2 ID in the AS. The Unicast transmission mode may be characterized by: Support of one PC5-RRC connection between peer UEs for the pair; Transmission and reception of control information and user traffic between peer UEs in sidelink; Support of sidelink HARQ feedback; Support of sidelink transmit power control; Support of RLC Acknowledged Mode (AM); and Detection of radio link failure for the PC5-RRC connection. The Groupcast transmission may be characterized by: Transmission and reception of user traffic among UEs belonging to a group in sidelink; and Support of sidelink HARQ feedback. The Broadcast transmission may be characterized by: Transmission and reception of user traffic among UEs in sidelink.

A Source Layer-2 ID, a Destination Layer-2 ID and a PC5 Link Identifier may be used for NR sidelink communication. The Source Layer-2 ID may be a link-layer identity that identifies a device or a group of devices that are recipients of sidelink communication frames. The Destination Layer-2 ID may be a link-layer identity that identifies a device that originates sidelink communication frames. In some examples, the Source Layer-2 ID and the Destination Layer-2 ID may be assigned by a management function in the Core Network. The Source Layer-2 ID may identify the sender of the data in NR sidelink communication. The Source Layer-2 ID may be 24 bits long and may be split in the medium access control (MAC) layer into two-bit strings: One bit string may be the LSB part (8 bits) of Source Layer-2 ID and forwarded to physical layer of the sender. This may identify the source of the intended data in sidelink control information and may be used for filtering of packets at the physical layer of the receiver; and the Second bit string may be the MSB part (16 bits) of the Source Layer-2 ID and may be carried within the MAC header. This may be used for filtering of packets at the MAC layer of the receiver. The Destination Layer-2 ID may identify the target of the data in NR sidelink communication. For NR sidelink communication, the Destination Layer-2 ID may be 24 bits long and may be split in the MAC layer into two-bit strings: One bit string may be the LSB part (16 bits) of Destination Layer-2 ID and forwarded to physical layer of the sender. This may identify the target of the intended data in sidelink control information and may be used for filtering of packets at the physical layer of the receiver; and the Second bit string may be the MSB part (8 bits) of the Destination Layer-2 ID and may be carried within the MAC header. This may be used for filtering of packets at the MAC layer of the receiver. The PC5 Link Identifier may uniquely identify the PC5 unicast link in a UE for the lifetime of the PC5 unicast link. The PC5 Link Identifier may be used to indicate the PC5 unicast link whose sidelink Radio Link failure (RLF) declaration was made and PC5-RRC connection was released.

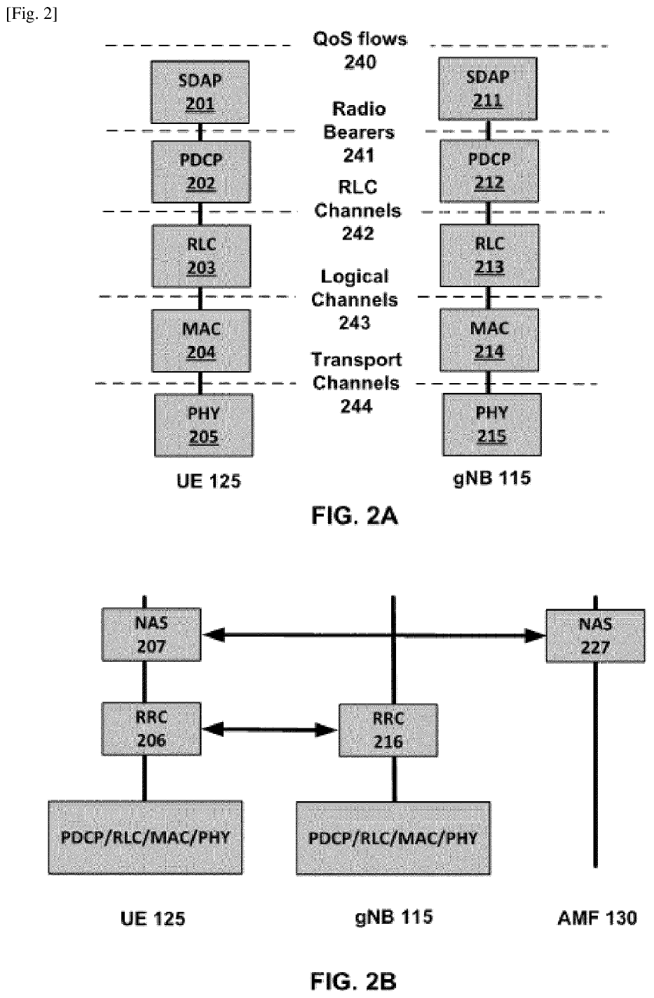

FIG. 2A and FIG. 2B show examples of radio protocol stacks for user plane and control plane, respectively, according to some aspects of one or more exemplary embodiments of the present disclosure. As shown in FIG. 2A, the protocol stack for the user plane of the Uu interface (between the UE 125 and the gNB 115) includes Service Data Adaptation Protocol (SDAP) 201 and SDAP 211, Packet Data Convergence Protocol (PDCP) 202 and PDCP 212, Radio Link Control (RLC) 203 and RLC 213, MAC 204 and MAC 214 sublayers of layer 2 and Physical (PHY) 205 and PHY 215 layer (layer 1 also referred to as L1).

The PHY 205 and PHY 215 offer transport channels 244 to the MAC 204 and MAC 214 sublayer. The MAC 204 and MAC 214 sublayer offer logical channels 243 to the RLC 203 and RLC 213 sublayer. The RLC 203 and RLC 213 sublayer offer RLC channels 242 to the PDCP 202 and PCP 212 sublayer. The PDCP 202 and PDCP 212 sublayer offer radio bearers 241 to the SDAP 201 and SDAP 211 sublayer. Radio bearers may be categorized into two groups: Data Radio Bearers (DRBs) for user plane data and Signaling Radio Bearers (SRBs) for control plane data. The SDAP 201 and SDAP 211 sublayer offers QoS flows 240 to 5GC.

The main services and functions of the MAC 204 or MAC 214 sublayer include: mapping between logical channels and transport channels; Multiplexing/demultiplexing of MAC Service Data Units (SDUs) belonging to one or different logical channels into/from Transport Blocks (TB) delivered to/from the physical layer on transport channels; Scheduling information reporting; Error correction through Hybrid Automatic Repeat Request (HARQ) (one HARQ entity per cell in case of carrier aggregation (CA)); Priority handling between UEs by means of dynamic scheduling; Priority handling between logical channels of one UE by means of Logical Channel Prioritization (LCP); Priority handling between overlapping resources of one UE; and Padding. A single MAC entity may support multiple numerologies, transmission timings and cells. Mapping restrictions in logical channel prioritization control which numerology(ies), cell(s), and transmission timing(s) a logical channel may use.

The HARQ functionality may ensure delivery between peer entities at Layer 1. A single HARQ process may support one TB when the physical layer is not configured for downlink/uplink spatial multiplexing, and when the physical layer is configured for downlink/uplink spatial multiplexing, a single HARQ process may support one or multiple TBs.

The RLC 203 or RLC 213 sublayer may support three transmission modes: Transparent Mode (TM); Unacknowledged Mode (UM); and Acknowledged Mode (AM). The RLC configuration may be per logical channel with no dependency on numerologies and/or transmission durations, and Automatic Repeat Request (ARQ) may operate on any of the numerologies and/or transmission durations the logical channel is configured with.

The main services and functions of the RLC 203 or RLC 213 sublayer depend on the transmission mode (e.g., TM, UM or AM) and may include: Transfer of upper layer PDUs; Sequence numbering independent of the one in PDCP (UM and AM); Error Correction through ARQ (AM only); Segmentation (AM and UM) and resegmentation (AM only) of RLC SDUs; Reassembly of SDU (AM and UM); Duplicate Detection (AM only); RLC SDU discard (AM and UM); RLC re-establishment; and Protocol error detection (AM only).

The automatic repeat request within the RLC 203 or RLC 213 sublayer may have the following characteristics: ARQ retransmits RLC SDUs or RLC SDU segments based on RLC status reports; Polling for RLC status report may be used when needed by RLC; RLC receiver may also trigger RLC status report after detecting a missing RLC SDU or RLC SDU segment.

The main services and functions of the PDCP 202 or PDCP 212 sublayer may include: Transfer of data (user plane or control plane); Maintenance of PDCP Sequence Numbers (SNs); Header compression and decompression using the Robust Header Compression (ROHC) protocol; Header compression and decompression using EHC protocol; Ciphering and deciphering; Integrity protection and integrity verification; Timer based SDU discard; Routing for split bearers; Duplication; Reordering and in-order delivery; Out-of-order delivery; and Duplicate discarding.

The main services and functions of SDAP 201 or SDAP 211 include: Mapping between a QoS flow and a data radio bearer; and Marking QoS Flow ID (QFI) in both downlink and uplink packets. A single protocol entity of SDAP may be configured for each individual PDU session.

As shown in FIG. 2B, the protocol stack of the control plane of the Uu interface (between the UE 125 and the gNB 115) includes PHY layer (layer 1), and MAC, RLC and PDCP sublayers of layer 2 as described above and in addition, the RRC 206 sublayer and RRC 216 sublayer. The main services and functions of the RRC 206 sublayer and the RRC 216 sublayer over the Uu interface include: Broadcast of System Information related to AS and NAS; Paging initiated by 5GC or NG-RAN; Establishment, maintenance and release of an RRC connection between the UE and NG-RAN (including Addition, modification and release of carrier aggregation; and Addition, modification and release of Dual Connectivity in NR or between E-UTRA and NR); Security functions including key management; Establishment, configuration, maintenance and release of SRBs and DRBs; Mobility functions (including Handover and context transfer; UE cell selection and reselection and control of cell selection and reselection; and Inter-RAT mobility); QoS management functions; UE measurement reporting and control of the reporting; Detection of and recovery from radio link failure; and NAS message transfer to/from NAS from/to UE. The NAS 207 and NAS 227 layer is a control protocol (terminated in AMF on the network side) that performs the functions such as authentication, mobility management, security control, etc.

The sidelink specific services and functions of the RRC sublayer over the Uu interface include: Configuration of sidelink resource allocation via system information or dedicated signaling; Reporting of UE sidelink information; Measurement configuration and reporting related to sidelink; and Reporting of UE assistance information for SL traffic pattern(s).

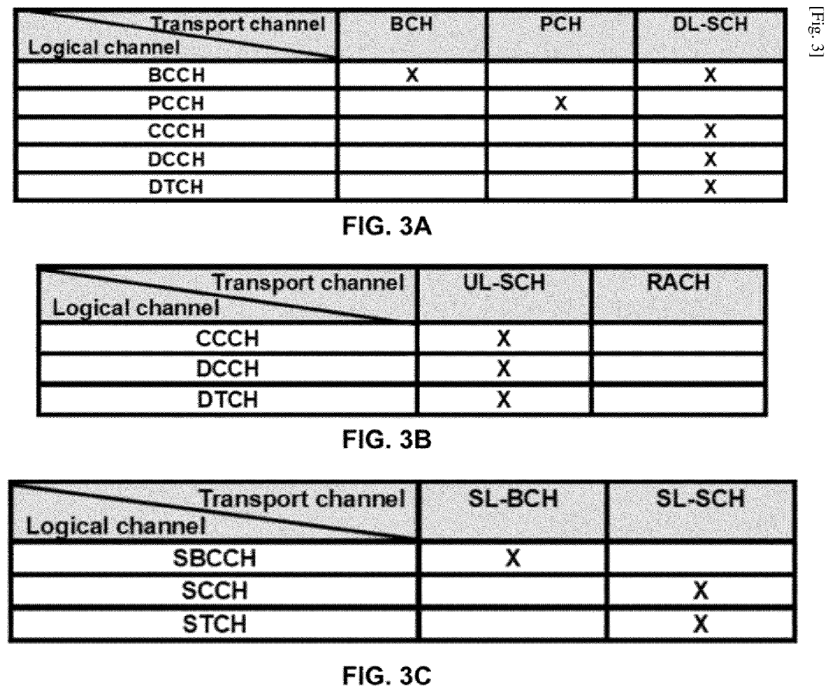

FIG. 3A, FIG. 3B and FIG. 3C show example mappings between logical channels and transport channels in downlink, uplink and sidelink, respectively, according to some aspects of one or more exemplary embodiments of the present disclosure. Different kinds of data transfer services may be offered by MAC. Each logical channel type may be defined by what type of information is transferred. Logical channels may be classified into two groups: Control Channels and Traffic Channels. Control channels may be used for the transfer of control plane information only. The Broadcast Control Channel (BCCH) is a downlink channel for broadcasting system control information. The Paging Control Channel (PCCH) is a downlink channel that carries paging messages. The Common Control Channel (CCCH) is channel for transmitting control information between UEs and network. This channel may be used for UEs having no RRC connection with the network. The Dedicated Control Channel (DCCH) is a point-to-point bi-directional channel that transmits dedicated control information between a UE and the network and may be used by UEs having an RRC connection. Traffic channels may be used for the transfer of user plane information only. The Dedicated Traffic Channel (DTCH) is a point-to-point channel, dedicated to one UE, for the transfer of user information. A DTCH may exist in both uplink and downlink. Sidelink Control Channel (SCCH) is a sidelink channel for transmitting control information (e.g., PC5-RRC and PC5-S messages) from one UE to other UE(s). Sidelink Traffic Channel (STCH) is a sidelink channel for transmitting user information from one UE to other UE(s). Sidelink Broadcast Control Channel (SBCCH) is a sidelink channel for broadcasting sidelink system information from one UE to other UE(s).

The downlink transport channel types include Broadcast Channel (BCH), Downlink Shared Channel (DL-SCH), and Paging Channel (PCH). The BCH may be characterized by: fixed, pre-defined transport format; and requirement to be broadcast in the entire coverage area of the cell, either as a single message or by beamforming different BCH instances. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; and the support for UE Discontinuous Reception (DRX) to enable UE power saving. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; support for UE discontinuous reception (DRX) to enable UE power saving. The PCH may be characterized by: support for UE discontinuous reception (DRX) to enable UE power saving (DRX cycle is indicated by the network to the UE); requirement to be broadcast in the entire coverage area of the cell, either as a single message or by beamforming different BCH instances; mapped to physical resources which can be used dynamically also for traffic/other control channels.

In downlink, the following connections between logical channels and transport channels may exist: BCCH may be mapped to BCH; BCCH may be mapped to DL-SCH; PCCH may be mapped to PCH; CCCH may be mapped to DL-SCH; DCCH may be mapped to DL-SCH; and DTCH may be mapped to DL-SCH.

The uplink transport channel types include Uplink Shared Channel (UL-SCH) and Random Access Channel(s) (RACH). The UL-SCH may be characterized by possibility to use beamforming; support for dynamic link adaptation by varying the transmit power and potentially modulation and coding; support for HARQ; support for both dynamic and semi-static resource allocation. The RACH may be characterized by limited control information; and collision risk.

In Uplink, the following connections between logical channels and transport channels may exist: CCCH may be mapped to UL-SCH; DCCH may be mapped to UL-SCH; and DTCH may be mapped to UL-SCH.

The sidelink transport channel types include: Sidelink broadcast channel (SL-BCH) and Sidelink shared channel (SL-SCH). The SL-BCH may be characterized by predefined transport format. The SL-SCH may be characterized by support for unicast transmission, groupcast transmission and broadcast transmission; support for both UE autonomous resource selection and scheduled resource allocation by NG-RAN; support for both dynamic and semi-static resource allocation when UE is allocated resources by the NG-RAN; support for HARQ; and support for dynamic link adaptation by varying the transmit power, modulation and coding.

In the sidelink, the following connections between logical channels and transport channels may exist: SCCH may be mapped to SL-SCH; STCH may be mapped to SL-SCH; and SBCCH may be mapped to SL-BCH.

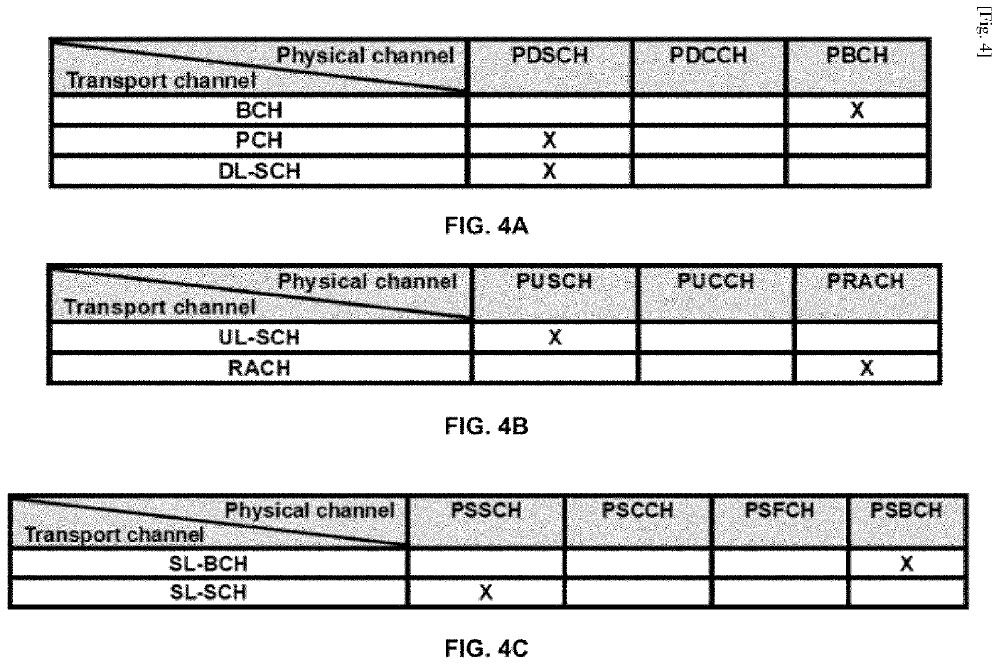

FIG. 4A, FIG. 4B and FIG. 4C show example mappings between transport channels and physical channels in downlink, uplink and sidelink, respectively, according to some aspects of one or more exemplary embodiments of the present disclosure. The physical channels in downlink include Physical Downlink Shared Channel (PDSCH), Physical Downlink Control Channel (PDCCH) and Physical Broadcast Channel (PBCH). The PCH and DL-SCH transport channels are mapped to the PDSCH. The BCH transport channel is mapped to the PBCH. A transport channel is not mapped to the PDCCH but Downlink Control Information (DCI) is transmitted via the PDCCH.

The physical channels in the uplink include Physical Uplink Shared Channel (PUSCH), Physical Uplink Control Channel (PUCCH) and Physical Random Access Channel (PRACH). The UL-SCH transport channel may be mapped to the PUSCH and the RACH transport channel may be mapped to the PRACH. A transport channel is not mapped to the PUCCH but Uplink Control Information (UCI) is transmitted via the PUCCH.

The physical channels in the sidelink include Physical Sidelink Shared Channel (PSSCH), Physical Sidelink Control Channel (PSCCH), Physical Sidelink Feedback Channel (PSFCH) and Physical Sidelink Broadcast Channel (PSBCH). The Physical Sidelink Control Channel (PSCCH) may indicate resource and other transmission parameters used by a UE for PSSCH. The Physical Sidelink Shared Channel (PSSCH) may transmit the TBs of data themselves, and control information for HARQ procedures and Channel State Information (CSI) feedback triggers, etc. At least six Orthogonal Frequency Division Multiplexing (OFDM) symbols within a slot may be used for PSSCH transmission. Physical Sidelink Feedback Channel (PSFCH) may carry the HARQ feedback over the sidelink from a UE which is an intended recipient of a PSSCH transmission to the UE which performed the transmission. PSFCH sequence may be transmitted in one PRB repeated over two OFDM symbols near the end of the sidelink resource in a slot. The SL-SCH transport channel may be mapped to the PSSCH. The SL-BCH may be mapped to PSBCH. No transport channel is mapped to the PSFCH but Sidelink Feedback Control Information (SFCI) may be mapped to the PSFCH. No transport channel is mapped to PSCCH but Sidelink Control Information (SCI) may be mapped to the PSCCH.

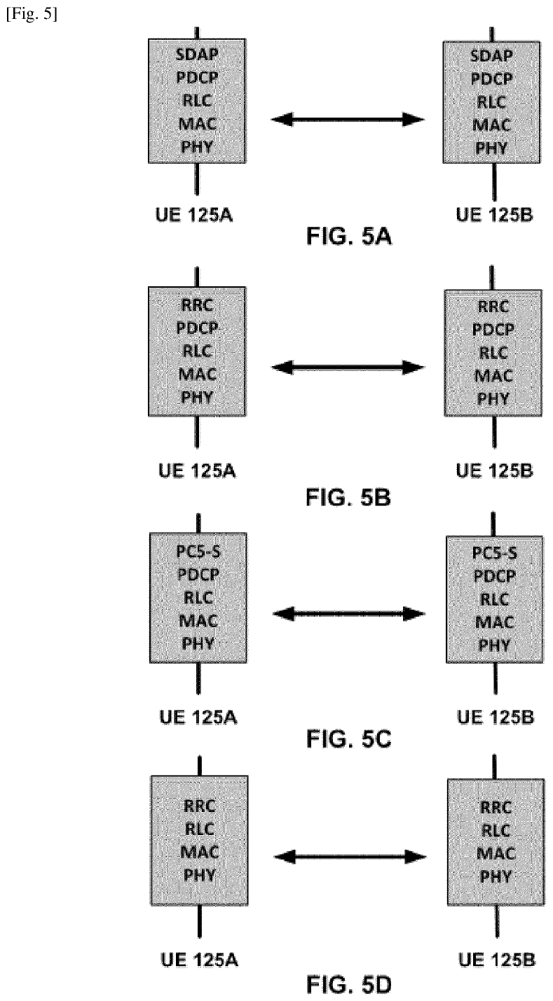

FIG. 5A, FIG. 5B, FIG. 5C and FIG. 5D show examples of radio protocol stacks for NR sidelink communication according to some aspects of one or more exemplary embodiments of the present disclosure. The AS protocol stack for user plane in the PC5 interface (i.e., for STCH) may consist of SDAP, PDCP, RLC and MAC sublayers, and the physical layer. The protocol stack of user plane is shown in FIG. 5A. The AS protocol stack for SBCCH in the PC5 interface may consist of RRC, RLC, MAC sublayers, and the physical layer as shown below in FIG. 5B. For support of PC5-S protocol, PC5-S is located on top of PDCP, RLC and MAC sublayers, and the physical layer in the control plane protocol stack for SCCH for PC5-S, as shown in FIG. 5C. The AS protocol stack for the control plane for SCCH for RRC in the PC5 interface consists of RRC, PDCP, RLC and MAC sublayers, and the physical layer. The protocol stack of control plane for SCCH for RRC is shown in FIG. 5D.

The Sidelink Radio Bearers (SLRBs) may be categorized into two groups: Sidelink Data Radio Bearers (SLDRB) for user plane data and Sidelink Signaling Radio Bearers (SLSRB) for control plane data. Separate SL SRBs using different SCCHs may be configured for PC5-RRC and PC5-S signaling, respectively.

The MAC sublayer may provide the following services and functions over the PC5 interface: Radio resource selection; Packet filtering; Priority handling between uplink and sidelink transmissions for a given UE; and Sidelink CSI reporting. With logical channel prioritization restrictions in MAC, only sidelink logical channels belonging to the same destination may be multiplexed into a MAC PDU for every unicast, groupcast and broadcast transmission which may be associated to the destination. For packet filtering, a SL-SCH MAC header including portions of both Source Layer-2 ID and a Destination Layer-2 ID may be added to a MAC PDU. The Logical Channel Identifier (LCID) included within a MAC subheader may uniquely identify a logical channel within the scope of the Source Layer-2 ID and Destination Layer-2 ID combination.

The services and functions of the RLC sublayer may be supported for sidelink. Both RLC Unacknowledged Mode (UM) and Acknowledged Mode (AM) may be used in unicast transmission while only UM may be used in groupcast or broadcast transmission. For UM, only unidirectional transmission may be supported for groupcast and broadcast.

The services and functions of the PDCP sublayer for the Uu interface may be supported for sidelink with some restrictions: Out-of-order delivery may be supported only for unicast transmission; and Duplication may not be supported over the PC5 interface.

The SDAP sublayer may provide the following service and function over the PC5 interface: Mapping between a QoS flow and a sidelink data radio bearer. There may be one SDAP entity per destination for one of unicast, groupcast and broadcast which is associated to the destination.

The RRC sublayer may provide the following services and functions over the PC5 interface: Transfer of a PC5-RRC message between peer UEs; Maintenance and release of a PC5-RRC connection between two UEs; and Detection of sidelink radio link failure for a PC5-RRC connection based on indication from MAC or RLC. A PC5-RRC connection may be a logical connection between two UEs for a pair of Source and Destination Layer-2 IDs which may be considered to be established after a corresponding PC5 unicast link is established. There may be one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages may be used for a UE to transfer UE capability and sidelink configuration including SL-DRB configuration to the peer UE. Both peer UEs may exchange their own UE capability and sidelink configuration using separate bi-directional procedures in both sidelink directions.

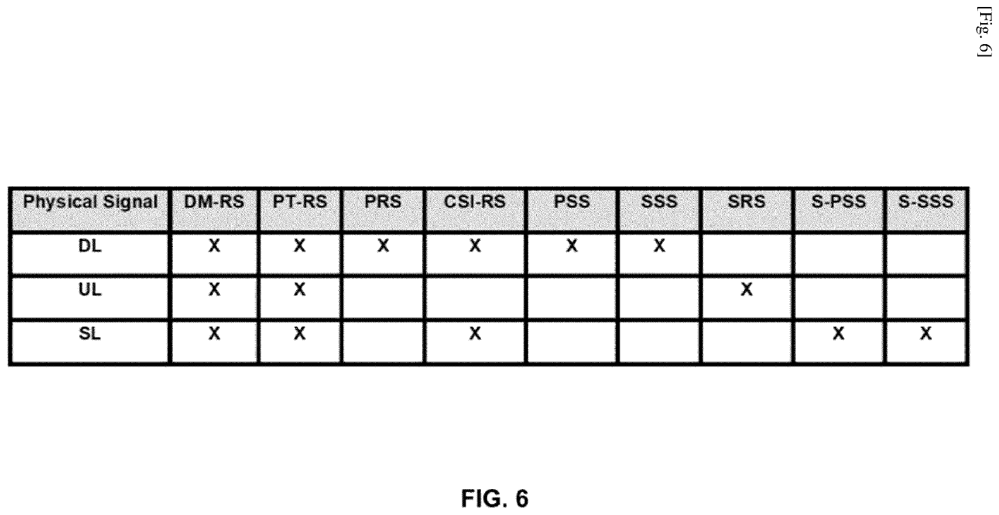

FIG. 6 shows example physical signals in downlink, uplink and sidelink according to some aspects of one or more exemplary embodiments of the present disclosure. The Demodulation Reference Signal (DM-RS) may be used in downlink, uplink and sidelink and may be used for channel estimation. DM-RS is a UE-specific reference signal and may be transmitted together with a physical channel in downlink, uplink or sidelink and may be used for channel estimation and coherent detection of the physical channel. The Phase Tracking Reference Signal (PT-RS) may be used in downlink, uplink and sidelink and may be used for tracking the phase and mitigating the performance loss due to phase noise. The PT-RS may be used mainly to estimate and minimize the effect of Common Phase Error (CPE) on system performance. Due to the phase noise properties, PT-RS signal may have a low density in the frequency domain and a high density in the time domain. PT-RS may occur in combination with DM-RS and when the network has configured PT-RS to be present. The Positioning Reference Signal (PRS) may be used in downlink for positioning using different positioning techniques. PRS may be used to measure the delays of the downlink transmissions by correlating the received signal from the base station with a local replica in the receiver. The Channel State Information Reference Signal (CSI-RS) may be used in downlink and sidelink. CSI-RS may be used for channel state estimation, Reference Signal Received Power (RSRP) measurement for mobility and beam management, time/frequency tracking for demodulation among other uses. CSI-RS may be configured UE-specifically but multiple users may share the same CSI-RS resource. The UE may determine CSI reports and transit them in the uplink to the base station using PUCCH or PUSCH. The CSI report may be carried in a sidelink MAC control element (CE). The Primary Synchronization Signal (PSS) and the Secondary Synchronization Signal (SSS) may be used for radio fame synchronization. The PSS and SSS may be used for the cell search procedure during the initial attach or for mobility purposes. The Sounding Reference Signal (SRS) may be used in uplink for uplink channel estimation. Similar to CSI-RS, the SRS may serve as QCL reference for other physical channels such that they can be configured and transmitted quasi-collocated with SRS. The Sidelink PSS (S-PSS) and Sidelink SSS (S-SSS) may be used in sidelink for sidelink synchronization.

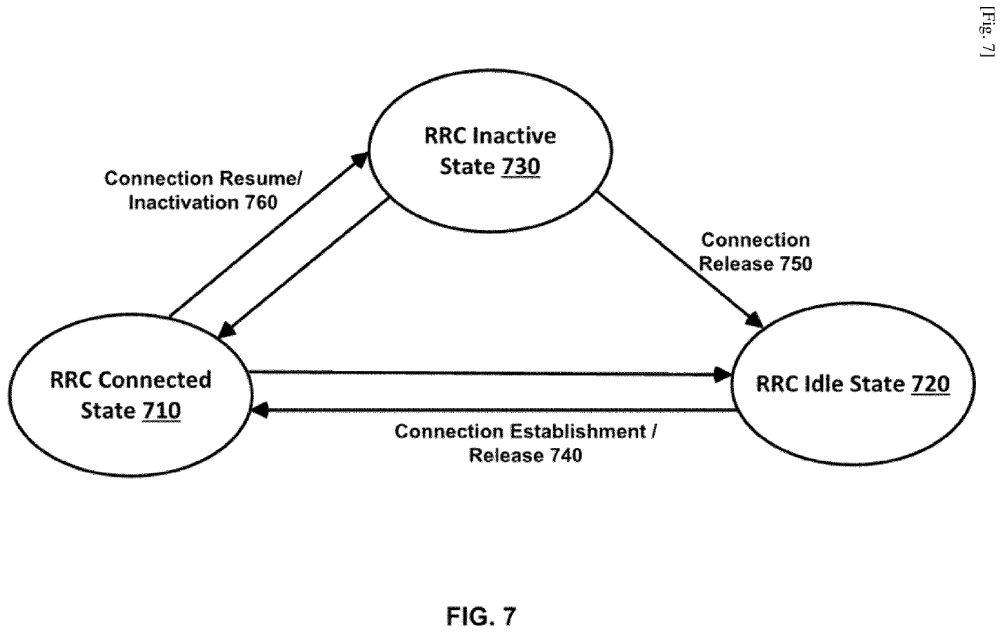

FIG. 7 shows examples of Radio Resource Control (RRC) states and transitioning between different RRC states according to some aspects of one or more exemplary embodiments of the present disclosure. A UE may be in one of three RRC states: RRC Connected State 710, RRC Idle State 720 and RRC Inactive state 730. After power up, the UE may be in RRC Idle state 720 and the UE may establish connection with the network using initial access and via an RRC connection establishment procedure to perform data transfer and/or to make/receive voice calls. Once RRC connection is established, the UE may be in RRC Connected State 710. The UE may transition from the RRC Idle state 720 to the RRC connected state 710 or from the RRC Connected State 710 to the RRC Idle state 720 using the RRC connection Establishment/Release procedures 740.

To reduce the signaling load and the latency resulting from frequent transitioning from the RRC Connected State 710 to the RRC Idle State 720 when the UE transmits frequent small data, the RRC Inactive State 730 may be used. In the RRC Inactive State 730, the AS context may be stored by both UE and gNB. This may result in faster state transition from the RRC Inactive State 730 to RRC Connected State 710. The UE may transition from the RRC Inactive State 730 to the RRC Connected State 710 or from the RRC Connected State 710 to the RRC Inactive State 730 using the RRC Connection Resume/Inactivation procedures 760. The UE may transition from the RRC Inactive State 730 to RRC Idle State 720 using an RRC Connection Release procedure 750.

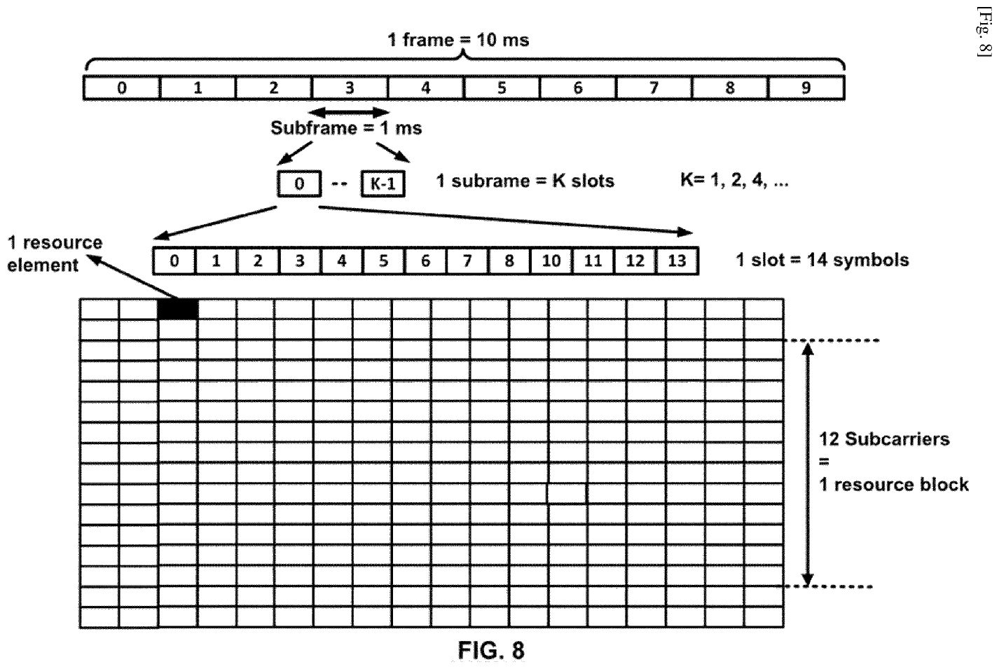

FIG. 8 shows example frame structure and physical resources according to some aspects of one or more exemplary embodiments of the present disclosure. The downlink or uplink or sidelink transmissions may be organized into frames with 10 ms duration, consisting of ten (0 to 9) 1 ms subframes. Each subframe may consist of k slots (k=1, 2, 4, . . . ), wherein the number of slots k per subframe may depend on the subcarrier spacing of the carrier on which the transmission takes place. The slot duration may be 14 (0 to 13) symbols with Normal Cyclic Prefix (CP) and 12 symbols with Extended CP and may scale in time as a function of the used sub-carrier spacing so that there is an integer number of slots in a subframe. FIG. 8 shows a resource grid in time and frequency domain. Each element of the resource grid, comprising one symbol in time and one subcarrier in frequency, is referred to as a Resource Element (RE). A Resource Block (RB) may be defined as 12 consecutive subcarriers in the frequency domain.

In some examples and with non-slot-based scheduling, the transmission of a packet may occur over a portion of a slot, for example, during two, four, or seven OFDM symbols which may also be referred to as mini-slots. The mini-slots may be used for low latency applications such as URLLC and operation in unlicensed bands. In some embodiments, the mini-slots may also be used for fast flexible scheduling of services (e.g., pre-emption of URLLC over eMBB).

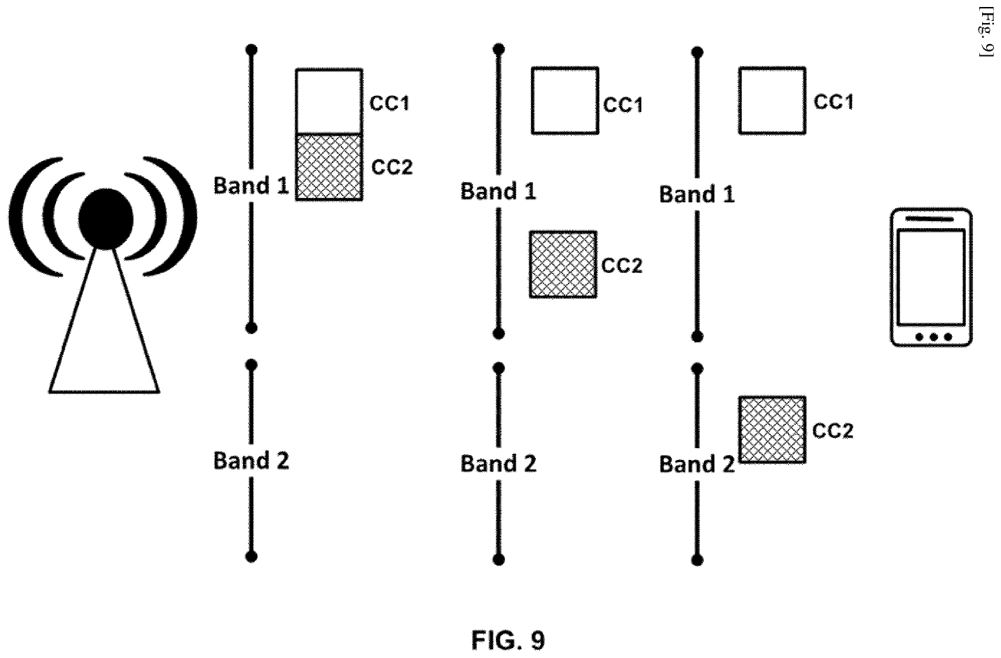

FIG. 9 shows example component carrier configurations in different carrier aggregation scenarios according to some aspects of one or more exemplary embodiments of the present disclosure. In Carrier Aggregation (CA), two or more Component Carriers (CCs) may be aggregated. A UE may simultaneously receive or transmit on one or multiple CCs depending on its capabilities. CA may be supported for both contiguous and non-contiguous CCs in the same band or on different bands as shown in FIG. 9. A gNB and the UE may communicate using a serving cell. A serving cell may be associated at least with one downlink CC (e.g., may be associated only with one downlink CC or may be associated with a downlink CC and an uplink CC). A serving cell may be a Primary Cell (PCell) or a Secondary cCell (SCell).

A UE may adjust the timing of its uplink transmissions using an uplink timing control procedure. A Timing Advance (TA) may be used to adjust the uplink frame timing relative to the downlink frame timing. The gNB may determine the desired Timing Advance setting and provides that to the UE. The UE may use the provided TA to determine its uplink transmit timing relative to the UE's observed downlink receive timing.

In the RRC Connected state, the gNB may be responsible for maintaining the timing advance (TA) to keep the L1 synchronized. Serving cells having uplink to which the same TA applies and using the same timing reference cell are grouped in a Timing Advance Group (TAG). A TAG may contain at least one serving cell with configured uplink. The mapping of a serving cell to a TAG may be configured by RRC. For the primary TAG, the UE may use the PCell as timing reference cell, except with shared spectrum channel access where an SCell may also be used as timing reference cell in certain cases. In a secondary TAG, the UE may use any of the activated SCells of this TAG as a timing reference cell and may not change it unless necessary.

Timing advance updates may be signaled by the gNB to the UE via MAC CE commands. Such commands may restart a TAG-specific timer which may indicate whether the L1 can be synchronized or not: when the timer is running, the L1 may be considered synchronized, otherwise, the L1 may be considered non-synchronized (in which case uplink transmission may only take place on PRACH).

A UE with single TA capability for CA may simultaneously receive and/or transmit on multiple CCs corresponding to multiple serving cells sharing the same TA (multiple serving cells grouped in one TAG). A UE with multiple TA capability for CA may simultaneously receive and/or transmit on multiple CCs corresponding to multiple serving cells with different TAs (multiple serving cells grouped in multiple TAGs). The NG-RAN may ensure that each TAG contains at least one serving cell. A non-CA capable UE may receive on a single CC and may transmit on a single CC corresponding to one serving cell only (one serving cell in one TAG).

The multi-carrier nature of the physical layer in case of CA may be exposed to the MAC layer and one HARQ entity may be required per serving cell. When CA is configured, the UE may have one RRC connection with the network. At RRC connection establishment/re-establishment/handover, one serving cell (e.g., the PCell) may provide the NAS mobility information. Depending on UE capabilities, SCells may be configured to form together with the PCell a set of serving cells. The configured set of serving cells for a UE may consist of one PCell and one or more SCells. The reconfiguration, addition and removal of SCells may be performed by RRC.

In a dual connectivity scenario, a UE may be configured with a plurality of cells comprising a Master Cell Group (MCG) for communications with a master base station, a Secondary Cell Group (SCG) for communications with a secondary base station, and two MAC entities: one MAC entity and for the MCG for communications with the master base station and one MAC entity for the SCG for communications with the secondary base station.

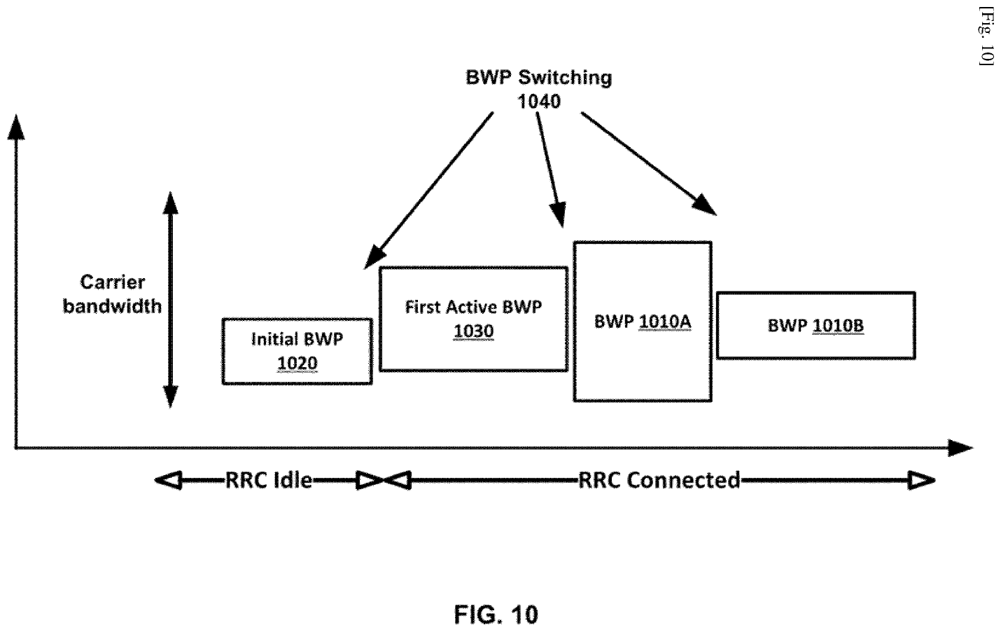

FIG. 10 shows example bandwidth part configuration and switching according to some aspects of one or more exemplary embodiments of the present disclosure. The UE may be configured with one or more Bandwidth Parts (BWPs) 1010 (e.g., 1010A, 1010B) on a given component carrier. In some examples, one of the one or more bandwidth parts may be active at a time. The active bandwidth part may define the UE's operating bandwidth within the cell's operating bandwidth. For initial access, and until the UE's configuration in a cell is received, initial bandwidth part 1020 determined from system information may be used. With Bandwidth Adaptation (BA), for example, through BWP switching 1040, the receive and transmit bandwidth of a UE may not be as large as the bandwidth of the cell and may be adjusted. For example, the width may be ordered to change (e.g., to shrink during period of low activity to save power); the location may move in the frequency domain (e.g., to increase scheduling flexibility); and the subcarrier spacing may be ordered to change (e.g., to allow different services). The first active BWP 1030 may be the active BWP upon RRC (re-)configuration for a PCell or activation of an SCell.

For a downlink BWP or uplink BWP in a set of downlink BWPs or uplink BWPs, respectively, the UE may be provided the following configuration parameters: a Subcarrier Spacing (SCS); a cyclic prefix; a common RB and a number of contiguous RBs; an index in the set of downlink BWPs or uplink BWPs by respective BWP-Id; a set of BWP-common and a set of BWP-dedicated parameters. A BWP may be associated with an OFDM numerology according to the configured subcarrier spacing and cyclic prefix for the BWP. For a serving cell, a UE may be provided by a default downlink BWP among the configured downlink BWPs. If a UE is not provided a default downlink BWP, the default downlink BWP may be the initial downlink BWP.

A downlink BWP may be associated with a BWP inactivity timer. If the BWP inactivity timer associated with the active downlink BWP expires and if the default downlink BWP is configured, the UE may perform BWP switching to the default BWP. If the BWP inactivity timer associated with the active downlink BWP expires and if the default downlink BWP is not configured, the UE may perform BWP switching to the initial downlink BWP.

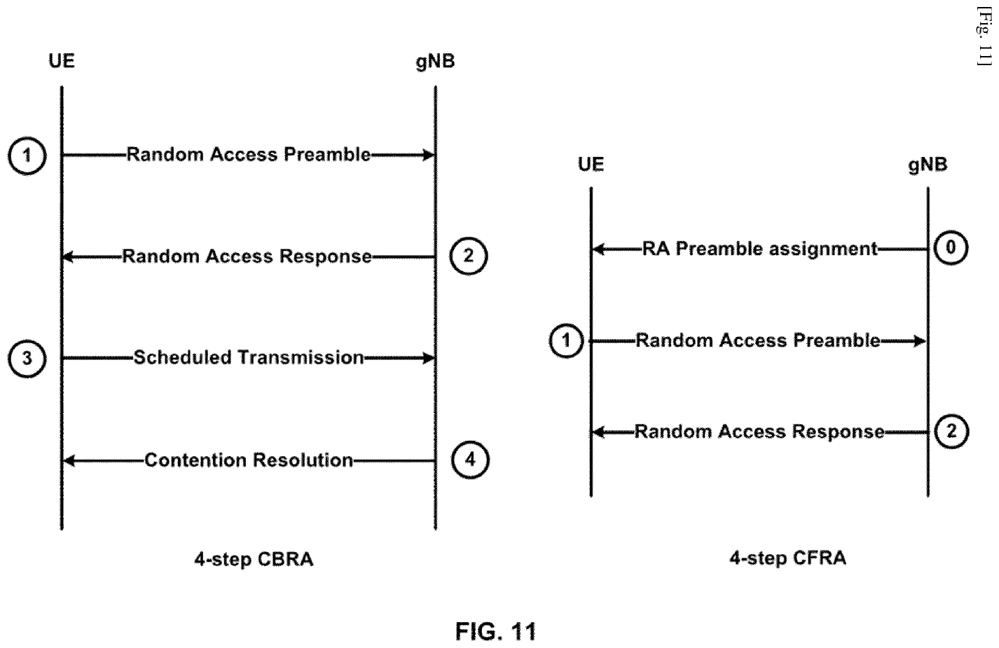

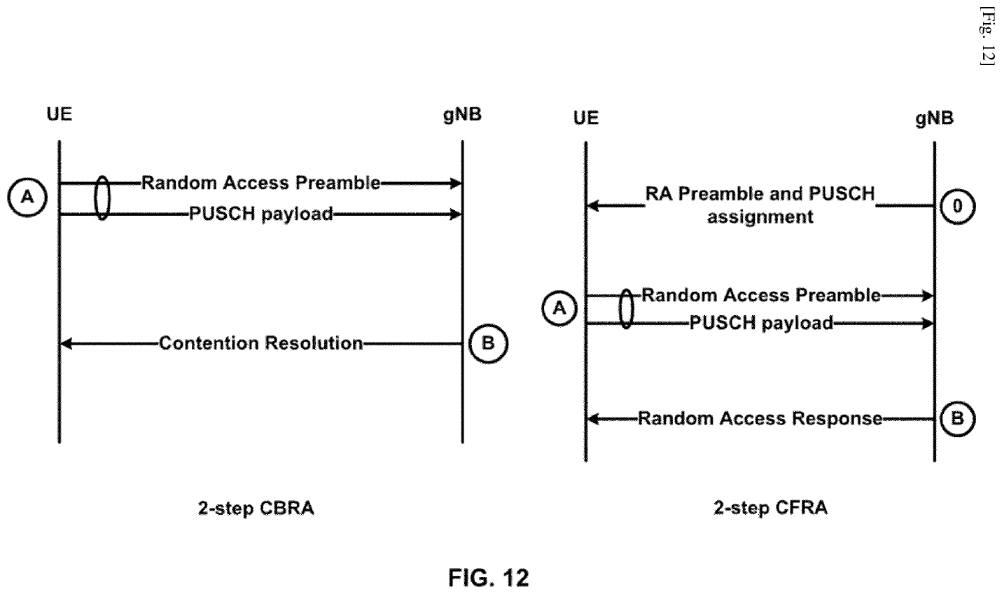

FIG. 11 shows example four-step contention-based random access (CBRA) and contention-free random access (CFRA) processes according to some aspects of one or more exemplary embodiments of the present disclosure. FIG. 12 shows example two-step contention-based random access (CBRA) and contention-free random access (CFRA) processes according to some aspects of one or more exemplary embodiments of the present disclosure. The random access procedure may be triggered by a number of events, for example: Initial access from RRC Idle State; RRC Connection Reestablishment procedure; downlink or uplink data arrival during RRC Connected State when uplink synchronization status is “non-synchronized”; uplink data arrival during RRC Connected State when there are no PUCCH resources for Scheduling Request (SR) available; SR failure; Request by RRC upon synchronous reconfiguration (e.g., handover); Transition from RRC Inactive State; to establish time alignment for a secondary TAG; Request for Other System Information (SI); Beam Failure Recovery (BFR); Consistent uplink Listen-Before-Talk (LBT) failure on PCell.

Two types of Random Access (RA) procedure may be supported: 4-step RA type with MSG1 and 2-step RA type with MSGA. Both types of RA procedure may support Contention-Based Random Access (CBRA) and Contention-Free Random Access (CFRA) as shown in FIG. 11 and FIG. 12.

The UE may select the type of random access at initiation of the random access procedure based on network configuration. When CFRA resources are not configured, a RSRP threshold may be used by the UE to select between 2-step RA type and 4-step RA type. When CFRA resources for 4-step RA type are configured, UE may perform random access with 4-step RA type. When CFRA resources for 2-step RA type are configured, UE may perform random access with 2-step RA type.

The MSG1 of the 4-step RA type may consist of a preamble on PRACH (Step 1 of CBRA in FIG. 11). After MSG1 transmission, the UE may monitor for a response from the network within a configured window (Step 2 of CBRA in FIG. 11). For CFRA, dedicated preamble for MSG1 transmission may be assigned by the network (Step 0 of CFRA of FIG. 11) and upon receiving Random Access Response (RAR) from the network, the UE may end the random access procedure as shown in FIG. 11 (Steps 1 and 2 of CFRA in FIG. 11). For CBRA, upon reception of the random access response (Step 2 of CBRA in FIG. 11), the UE may send MSG3 using the uplink grant scheduled in the random access response (Step 3 of CBRA in FIG. 11) and may monitor contention resolution as shown in FIG. 11 (Step 4 of CBRA in FIG. 11). If contention resolution is not successful after MSG3 (re)transmission(s), the UE may go back to MSG1 transmission.

The MSGA of the 2-step RA type may include a preamble on PRACH and a payload on PUSCH (e.g., Step A of CBRA in FIG. 12). After MSGA transmission, the UE may monitor for a response from the network within a configured window. For CFRA, dedicated preamble and PUSCH resource may be configured for MSGA transmission (Steps 0 and A of CFRA in FIG. 12) and upon receiving the network response (Step B of CFRA in FIG. 12), the UE may end the random access procedure as shown in FIG. 12. For CBRA, if contention resolution is successful upon receiving the network response (Step B of CBRA in FIG. 12), the UE may end the random access procedure as shown in FIG. 12; while if fallback indication is received in MSGB, the UE may perform MSG3 transmission using the uplink grant scheduled in the fallback indication and may monitor contention resolution. If contention resolution is not successful after MSG3 (re)transmission(s), the UE may go back to MSGA transmission.

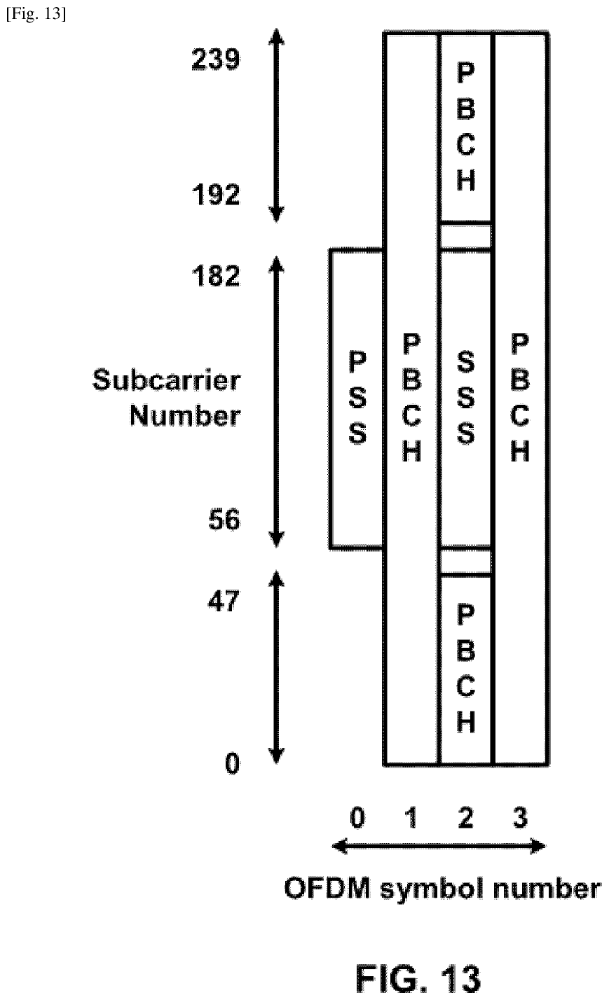

FIG. 13 shows example time and frequency structure of Synchronization Signal and Physical Broadcast Channel (PBCH) Block (SSB) according to some aspects of one or more exemplary embodiments of the present disclosure. The SS/PBCH Block (SSB) may consist of Primary and Secondary Synchronization Signals (PSS, SSS), each occupying 1 symbol and 127 subcarriers (e.g., subcarrier numbers 56 to 182 in FIG. 13), and PBCH spanning across 3 OFDM symbols and 240 subcarriers, but on one symbol leaving an unused part in the middle for SSS as show in FIG. 13. The possible time locations of SSBs within a half-frame may be determined by sub-carrier spacing and the periodicity of the half-frames, where SSBs are transmitted, may be configured by the network. During a half-frame, different SSBs may be transmitted in different spatial directions (i.e., using different beams, spanning the coverage area of a cell).

The PBCH may be used to carry Master Information Block (MIB) used by a UE during cell search and initial access procedures. The UE may first decode PBCH/MIB to receive other system information. The MIB may provide the UE with parameters required to acquire System Information Block 1 (SIB1), more specifically, information required for monitoring of PDCCH for scheduling PDSCH that carries SIB1. In addition, MIB may indicate cell barred status information. The MIB and SIB1 may be collectively referred to as the minimum system information (SI) and SIB1 may be referred to as remaining minimum system information (RMSI). The other system information blocks (SIBs) (e.g., SIB2, SIB3, . . . , SIB10 and SIBpos) may be referred to as Other SI. The Other SI may be periodically broadcast on DL-SCH, broadcast on-demand on DL-SCH (e.g., upon request from UEs in RRC Idle State, RRC Inactive State, or RRC connected State), or sent in a dedicated manner on DL-SCH to UEs in RRC Connected State (e.g., upon request, if configured by the network, from UEs in RRC Connected State or when the UE has an active BWP with no common search space configured).

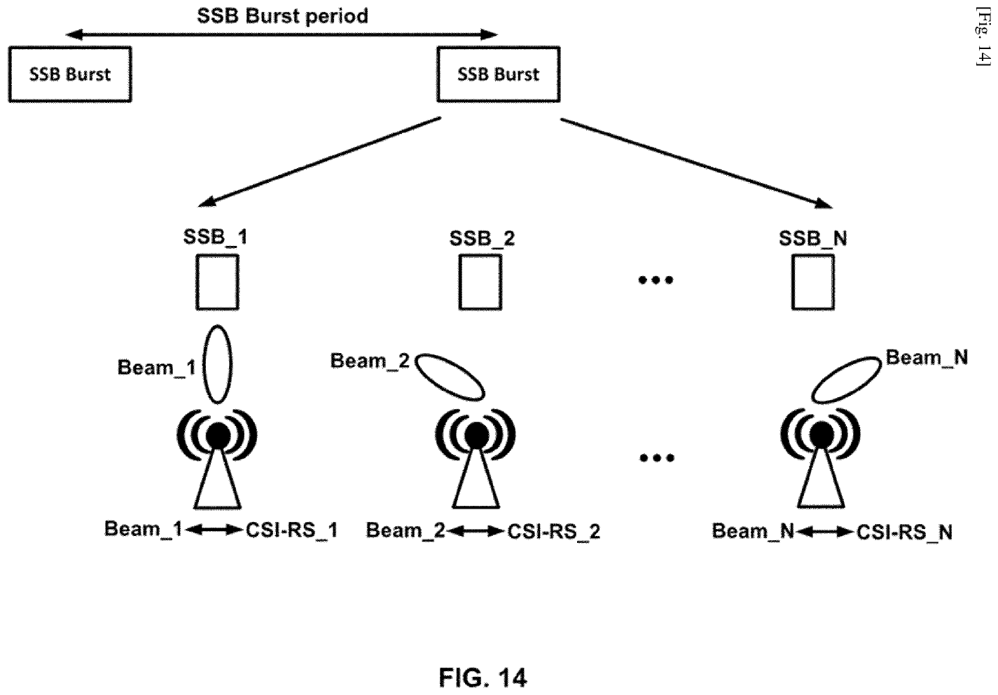

FIG. 14 shows example SSB burst transmissions according to some aspects of one or more exemplary embodiments of the present disclosure. An SSB burst may include N SSBs (e.g., SSB_1, SSB_2, . . . , SSB_N) and each SSB of the N SSBs may correspond to a beam (e.g., Beam_1, Beam_2, . . . , Beam_N). The SSB bursts may be transmitted according to a periodicity (e.g., SSB burst period). During a contention-based random access process, a UE may perform a random access resource selection process, wherein the UE first selects an SSB before selecting an RA preamble. The UE may select an SSB with an RSRP above a configured threshold value. In some embodiments, the UE may select any SSB if no SSB with RSRP above the configured threshold is available. A set of random access preambles may be associated with an SSB. After selecting an SSB, the UE may select a random access preamble from the set of random access preambles associated with the SSB and may transmit the selected random access preamble to start the random access process.

In some embodiments, a beam of the N beams may be associated with a CSI-RS resource (e.g., CSI-RS_1, CSI-RS_2, . . . , CSI-RS_N). A UE may measure CSI-RS resources and may select a CSI-RS with RSRP above a configured threshold value. The UE may select a random access preamble corresponding to the selected CSI-RS and may transmit the selected random access process to start the random access process. If there is no random access preamble associated with the selected CSI-RS, the UE may select a random access preamble corresponding to an SSB which is Quasi-Collocated with the selected CSI-RS.

In some embodiments, based on the UE measurements of the CSI-RS resources and the UE CSI reporting, the base station may determine a Transmission Configuration Indication (TCI) state and may indicate the TCI state to the UE, wherein the UE may use the indicated TCI state for reception of downlink control information (e.g., via PDCCH) or data (e.g., via PDSCH). The UE may use the indicated TCI state for using the appropriate beam for reception of data or control information. The indication of the TCI states may be using RRC configuration or in combination of RRC signaling and dynamic signaling (e.g., via a MAC control element (MAC CE) and/or based on a value of field in the downlink control information that schedules the downlink transmission). The TCI state may indicate a Quasi-Colocation (QCL) relationship between a downlink reference signal such as CSI-RS and the DM-RS associated with the downlink control or data channels (e.g., PDCCH or PDSCH, respectively).

In some embodiments, the UE may be configured with a list of up to M TCI-State configurations, using Physical Downlink Shared Channel (PDSCH) configuration parameters, to decode PDSCH according to a detected PDCCH with DCI intended for the UE and the given serving cell, where M may depend on the UE capability. Each TCI-State may contain parameters for configuring a QCL relationship between one or two downlink reference signals and the DM-RS ports of the PDSCH, the DM-RS port of PDCCH or the CSI-RS port(s) of a CSI-RS resource. The quasi co-location relationship may be configured by one or more RRC parameters. The quasi co-location types corresponding to each DL RS may take one of the following values: ‘QCL-TypeA’: {Doppler shift, Doppler spread, average delay, delay spread}; ‘QCL-TypeB’: {Doppler shift, Doppler spread}; ‘QCL-TypeC’: {Doppler shift, average delay}; ‘QCL-TypeD’: {Spatial Rx parameter}. The UE may receive an activation command (e.g., a MAC CE), used to map TCI states to the codepoints of a DCI field.

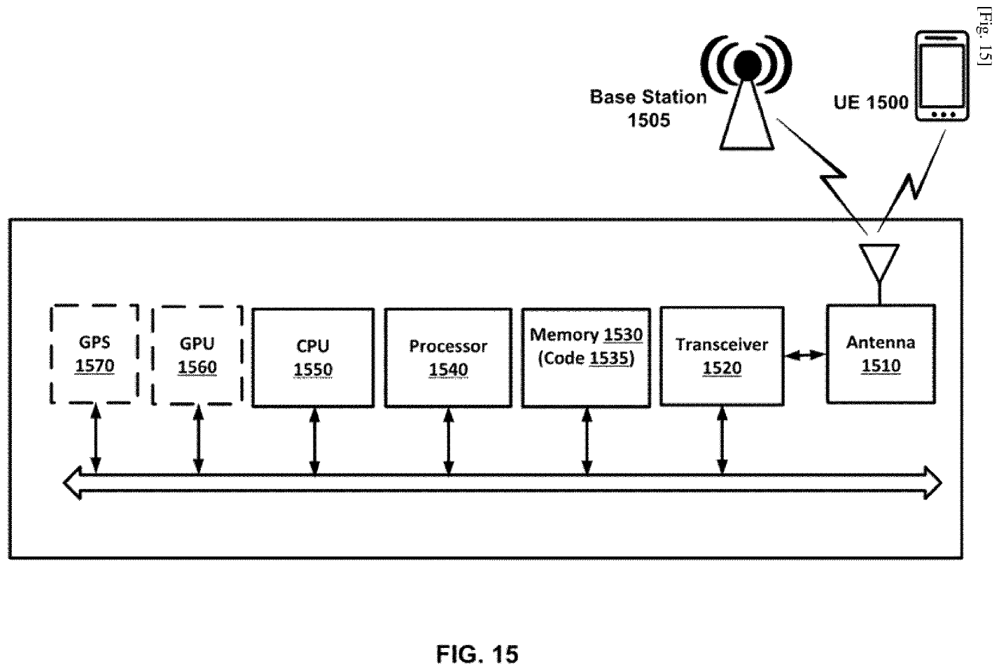

FIG. 15 shows example components of a user equipment and a base station for transmission and/or reception according to some aspects of one or more exemplary embodiments of the present disclosure. Still further, UEs 125 may also include components or subcomponents integrated into other devices, such as vehicles, to provide wireless communication functionality with nodes in the RAN, other UEs, satellite communications as described herein. Such other devices may have other functionality or multiple functionalities in addition to wireless communications. Accordingly, reference to UE may include the individual components facilitating the wireless communication as well as the entire device that incorporates components for facilitating wireless communications.

The Antenna 1510 may be used for transmission or reception of electromagnetic signals. The Antenna 1510 may comprise one or more antenna elements and may enable different input-output antenna configurations including Multiple-Input Multiple Output (MIMO) configuration, Multiple-Input Single-Output (MISO) configuration and Single-Input Multiple-Output (SIMO) configuration. In some embodiments, the Antenna 1510 may enable a massive MIMO configuration with tens or hundreds of antenna elements. The Antenna 1510 may enable other multi-antenna techniques such as beamforming. In some examples and depending on the UE 1500 capabilities or the type of UE 1500 (e.g., a low-complexity UE), the UE 1500 may support a single antenna only.

The transceiver 1520 may communicate bi-directionally, via the Antenna 1510, wireless links as described herein. For example, the transceiver 1520 may represent a wireless transceiver at the UE and may communicate bi-directionally with the wireless transceiver at the base station or vice versa. The transceiver 1520 may include a modem to modulate the packets and provide the modulated packets to the Antenna 1510 for transmission, and to demodulate packets received from the Antenna 1510.

The memory 1530 may include RAM and ROM. The memory 1530 may store computer-readable, computer-executable code 1535 including instructions that, when executed, cause the processor to perform various functions described herein. In some examples, the memory 1530 may contain, among other things, a Basic Input/output System (BIOS) which may control basic hardware or software operation such as the interaction with peripheral components or devices.

The processor 1540 may include a hardware device with processing capability (e.g., a general-purpose processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or any combination thereof). In some examples, the processor 1540 may be configured to operate a memory using a memory controller. In other examples, a memory controller may be integrated into the processor 1540. The processor 1540 may be configured to execute computer-readable instructions stored in a memory (e.g., the memory 1530) to cause the UE 1500 or the base station 1505 to perform various functions.

The CPU 1550 may perform basic arithmetic, logic, controlling, and Input/output (I/O) operations specified by the computer instructions in the Memory 1530. The UE 1500 and/or the base station 1505 may include additional peripheral components such as a graphics processing unit (GPU) 1560 and a Global Positioning System (GPS) 1570. The GPU 1560 is a specialized circuitry for rapid manipulation and altering of the Memory 1530 for accelerating the processing performance of the UE 1500 and/or the base station 1505. The GPS 1570 may be used for enabling location-based services or other services for example based on geographical position of the UE 1500.

In some example, MBS services may be enabled via single-cell transmission. MBS may be transmitted in the coverage of a single cell. One or more Multicast/Broadcast control channels (e.g., MCCHs) and one or more Multicast/Broadcast data channels (e.g., MTCHs) may be mapped on DL-SCH. The scheduling may be done by the gNB. The Multicast/Broadcast control channel and the Multicast/Broadcast data channel transmissions may be indicated by a logical channel specific RNTI on PDCCH. In some examples, a one-to-one mapping between a service identifier such as a temporary mobile group identifier (TMGI) and a RAN level identifier such as a group identifier (G-RNTI) may be used for the reception of the DL-SCH to which a Multicast/Broadcast data channel may be mapped. In some examples, a single transmission may be used for DL-SCH associated with the Multicast/Broadcast control channel and/or the Multicast/Broadcast data channel transmissions and HARQ or RLC retransmissions may not be used and/or an RLC Unacknowledged Mode (RLC UM) may be used. In other examples some feedback (e.g., HARQ feedback or RLC feedback) may be used for transmissions via Multicast/Broadcast control channel and/or Multicast/Broadcast data channels.

In some example, for Multicast/Broadcast data channel, the following scheduling information may be provided on Multicast/Broadcast control channel: a Multicast/Broadcast data channel scheduling cycle, a Multicast/Broadcast data channel onduration (e.g., duration that the UE waits for, after waking up from DRX, to receive PDCCHs), a Multicast/Broadcast data channel inactivity timer (e.g., duration that the UE waits to successfully decode a PDCCH, from the last successful decoding of a PDCCH indicating the DL-SCH to which this Multicast/Broadcast data channel is mapped, failing which it re-enters DRX).

In some examples, one or more UE identities may be related to MBS transmissions. The one or more identities may comprise at least one of: one or more first RNTIs that identify transmissions of the Multicast/Broadcast control channel; one or more second RNTIs that identify transmissions of a Multicast/Broadcast data channels. The one or more first RNTIs that identify transmissions of the Multicast/Broadcast control channel may comprise a single cell RNTI (SC-RNTI, other names may be used). The one or more second RNTIs that identify transmissions of a Multicast/Broadcast data channels may comprise a G-RNTI (nG-RNTI or other names may be used).

In some examples, one or more logical channels may be related to MBS transmissions. The one or more logical channels may comprise a Multicast/Broadcast control channel. The Multicast/Broadcast control channel may be a point-to-multipoint downlink channel used for transmitting MBS control information from the network to the UE, for one or several Multicast/Broadcast data channel. This channel may be used by UEs that receive or are interested to receive MBS. The one or more logical channels may comprise a Multicast/Broadcast data channel. This channel may be a point-to-multipoint downlink channel for transmitting MBS traffic data from the network.

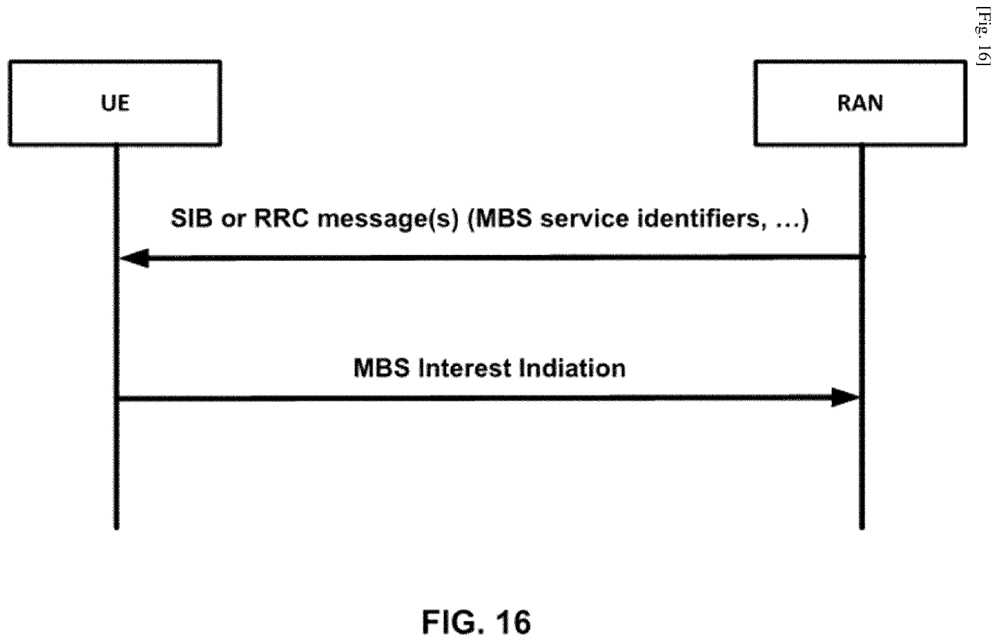

In some examples, a procedure may be used by the UE to inform RAN that the UE is configured for receiving or has been instructed to receive MBS service(s) via an MBS radio bearer, and if so, to inform the 5G RAN about the priority of MBS versus unicast reception or MBS service(s) reception in receive only mode. An example is shown in FIG. 16. The UE may transmit a message (e.g., an MBS interest indication message) message to inform RAN that the UE is receiving/available to receive or no longer receiving/available to receive MBS service(s). The UE may transmit the message based on receiving one or more messages (e.g., a SIB message or a unicast RRC message) from the network for example defining one or more MBS Service Area Identifiers of the current and/or neighboring carrier frequencies. Illustratively, the configuration of the UE to receive or availability to receive MBS services may be characterized as an “interest” in receiving MBS services.

In some examples, the UE may consider an MBS service to be part of the MBS services of interest if the UE is capable of receiving MBS services (e.g., via a single cell point to multipoint mechanism); and/or the UE is receiving or interested to receive this service via a bearer associated with MBS services; and/or one session of this service is ongoing or about to start; and/or at least one of the one or more MBS service identifiers indicated by network is of interest to the UE.

In some examples, control information for reception of MBS services may be provided on a specific logical channel: (e.g., a MCCH). The MCCH may carry one or more configuration messages which indicate the MBS sessions that are ongoing as well as the (corresponding) information on when each session may be scheduled, e.g., scheduling period, scheduling window and start offset. The one or more configuration messages may provide information about the neighbor cells transmitting the MBS sessions which may be ongoing on the current cell. In some examples, the UE may receive a single MBS service at a time, or more than one MBS services in parallel.

In some example, the MCCH information (e.g., the information transmitted in messages sent over the MCCH) may be transmitted periodically, using a configurable repetition period. The MCCH transmissions (and the associated radio resources and MCS) may be indicated on PDCCH.

In some examples, change of MCCH information may occur at specific radio frames/subframes/slots and/or a modification period may be used. For example, within a modification period, the same MCCH information may be transmitted a number of times, as defined by its scheduling (which is based on a repetition period). The modification period boundaries may be defined by SFN values for which SFN mod m=0, where m is the number of radio frames comprising the modification period. The modification period may be configured by a SIB or by RRC signaling.

In some examples, when the network changes (some of) the MCCH information, it may notify the UEs about the change in the first subframe/slot which may be used for MCCH transmission in a repetition period. Upon receiving a change notification, a UE interested to receive MBS services may acquire the new MCCH information starting from the same subframe/slot. The UE may apply the previously acquired MCCH information until the UE acquires the new MCCH information.

In an example, a system information block (SIB) may contain the information required to acquire the control information associated transmission of MBS. The information may comprise at least one of: one or more discontinuous reception (DRX) parameters for monitoring for scheduling information of the control information associated transmission of MBS, scheduling periodicity and offset for scheduling information of the control information associated transmission of MBS, modification period for modification of content of the control information associated transmission of MBS, repetition information for repetition of the control information associated transmission of MBS, etc.

In an example, an information element (IE) may provide configuration parameters indicating, for example, the list of ongoing MBS sessions transmitted via one or more bearers for each MBS session, one or more associated RNTIs (e.g., G-RNTI, other names may be used) and scheduling information. The configuration parameters may comprise at least one of: one or more timer values for discontinuous reception (DRX) (e.g., an inactivity timer or an On Duration timer), an RNTI for scrambling the scheduling and transmission of a Multicast/Broadcast traffic channel (e.g., MTCH, other names may be used), ongoing MBS session, one or more power control parameters, one or more scheduling periodicity and/or offset values for one or more MBS traffic channels, information about list of neighbor cells, etc.

In some examples a gNB or ng-eNB may comprise logical nodes that host some, all or parts of the user plane and/or control plane functionalities. For example, a gNB Central Unit (gNB-CU) may be a logical node hosting RRC, SDAP and PDCP protocols of the gNB or RRC and PDCP protocols of the en-gNB that controls the operation of one or more gNB-DUs. The gNB-CU may terminate the F1 interface connected with the gNB-DU. A gNB Distributed Unit (gNB-DU) may be a logical node hosting RLC, MAC and PHY layers of the gNB or en-gNB, and its operation may be partly controlled by gNB-CU. One gNB-DU may support one or multiple cells. One cell may be supported by only one gNB-DU. The gNB-DU may terminate the F1 interface connected with the gNB-CU. A gNB-CU-Control Plane (gNB-CU-CP) may be a logical node hosting the RRC and the control plane part of the PDCP protocol of the gNB-CU for an en-gNB or a gNB. The gNB-CU-CP may terminate the E1 interface connected with the gNB-CU-UP and the F1-C interface connected with the gNB-DU. A gNB-CU-User Plane (gNB-CU-UP) may be a logical node hosting the user plane part of the PDCP protocol of the gNB-CU for an en-gNB, and the user plane part of the PDCP protocol and the SDAP protocol of the gNB-CU for a gNB. The gNB-CU-UP may terminate the E1 interface connected with the gNB-CU-CP and the F1-U interface connected with the gNB-DU.

In some examples, paging may allow the network to reach UEs in RRC_IDLE and in RRC_INACTIVE state through Paging messages, and to notify UEs in RRC_IDLE, RRC_INACTIVE and RRC_CONNECTED state of system information change and earthquake and tsunami warning system (ETWS)/commercial mobile alert system (CMAS) indications through Short Messages. The Paging messages and Short Messages may be addressed with a specific RNTI (e.g., P-RNTI) on PDCCH, but while the former may be sent on PCCH, the latter may be sent over PDCCH directly.

In some examples, while in RRC_IDLE the UE may monitor the paging channels for CN-initiated paging; in RRC_INACTIVE the UE may also monitor paging channels for RAN-initiated paging. A UE need not monitor paging channels continuously though; Paging DRX may be defined where the UE in RRC_IDLE or RRC_INACTIVE may be only required to monitor paging channels during one Paging Occasion (PO) per DRX cycle. The Paging DRX cycles may be configured by the network: 1) For CN-initiated paging, a default cycle may be broadcast in system information; 2) For CN-initiated paging, a UE specific cycle may be configured via NAS signaling; 3) For RAN-initiated paging, a UE-specific cycle may be configured via RRC signaling. In some examples, a UE may use the shortest of the DRX cycles applicable e.g., a UE in RRC_IDLE may use the shortest of the first two cycles above, while a UE in RRC_INACTIVE may use the shortest of the three.

In some examples, the paging occasions (POs) of a UE for CN-initiated and RAN-initiated paging may be based on the same UE ID, resulting in overlapping POs for both. The number of different POs in a DRX cycle may be configurable via system information and a network may distribute UEs to those POs based on their IDs.

In some examples, when in RRC_CONNECTED, the UE may monitor the paging channels in any PO signaled in system information for SI change indication and public warning system (PWS) notification. In case of bandwidth adaptation (BA), a UE in RRC_CONNECTED may monitor paging channels on the active BWP with common search space configured.

In some examples, for operation with shared spectrum channel access, a UE may be configured for an additional number of PDCCH monitoring occasions in its PO to monitor for paging. In some examples, when the UE detects a PDCCH transmission within the UE's PO addressed with P-RNTI, the UE may not be required to monitor the subsequent PDCCH monitoring occasions within this PO.

In some examples, at UE context release, the NG-RAN node may provide the AMF with a list of recommended cells and NG-RAN nodes as assistance info for subsequent paging. The AMF may also provide Paging Attempt Information consisting of a Paging Attempt Count and the Intended Number of Paging Attempts and may include the Next Paging Area Scope. If Paging Attempt Information is included in the Paging message, each paged NG-RAN node may receive the same information during a paging attempt. The Paging Attempt Count may be increased by one at each new paging attempt. The Next Paging Area Scope, when present, may indicate whether the AMF plans to modify the paging area currently selected at next paging attempt. If the UE has changed its state to CM CONNECTED the Paging Attempt Count may be reset.

In some examples, at RAN Paging, the serving NG-RAN node may provide RAN Paging area information. The serving NG-RAN node may also provide RAN Paging attempt information. Each paged NG-RAN node may receive the same RAN Paging attempt information during a paging attempt with the following content: Paging Attempt Count, the intended number of paging attempts and the Next Paging Area Scope. The Paging Attempt Count may be increased by one at each new paging attempt. The Next Paging Area Scope, when present, may indicate whether the serving NG_RAN node plans to modify the RAN Paging Area currently selected at next paging attempt. If the UE leaves RRC_INACTIVE state, the Paging Attempt Count may be reset.

In some examples, a paging procedure may be used to transmit paging information to a UE in RRC_IDLE or RRC_INACTIVE. The network may initiate the paging procedure by transmitting the Paging message at the UE's paging occasion. The network may address multiple UEs within a Paging message by including one PagingRecord for each UE.

In some examples, upon receiving the Paging message, if in RRC_IDLE, for each of the PagingRecord, if any, included in the Paging message: if the ue-Identity included in the PagingRecord matches the UE identity allocated by upper layers: the UE may forward the ue-Identity and accessType (if present) to the upper layers.

In some examples, upon receiving the Paging message, if in RRC_INACTIVE, for each of the PagingRecord, if any, included in the Paging message: if the ue-Identity included in the PagingRecord matches the UE's stored fullI-RNTI: if the UE is configured by upper layers with Access Identity 1: the UE may initiate the RRC connection resumption procedure with resumeCause set to mps-PriorityAccess.

In some examples, upon receiving the Paging message, if in RRC_INACTIVE, for each of the PagingRecord, if any, included in the Paging message: if the ue-Identity included in the PagingRecord matches the UE's stored fullI-RNTI: if the UE is configured by upper layers with Access Identity 2: the UE may initiate the RRC connection resumption procedure with resumeCause set to mes-PriorityAccess.

In some examples, upon receiving the Paging message, if in RRC_INACTIVE, for each of the PagingRecord, if any, included in the Paging message: if the ue-Identity included in the PagingRecord matches the UE's stored fullI-RNTI: if the UE is configured by upper layers with one or more Access Identities equal to 11-15: the UE may initiate the RRC connection resumption procedure with resumeCause set to highPriorityAccess.

In some examples, upon receiving the Paging message, if in RRC_INACTIVE, for each of the PagingRecord, if any, included in the Paging message: if the ue-Identity included in the PagingRecord matches the UE's stored fullI-RNTI: the UE may initiate the RRC connection resumption procedure with resumeCause set to mt-Access.

In some examples, upon receiving the Paging message, if in RRC_INACTIVE, for each of the PagingRecord, if any, included in the Paging message: else if the ue-Identity included in the PagingRecord matches the UE identity allocated by upper layers: the UE may forward the ue-Identity to upper layers and accessType (if present) to the upper layers and the UE may perform the actions upon going to RRC_IDLE with release cause ‘other’.

In some examples, the PCCH-Message class may be the set of RRC messages that may be sent from the Network to the UE on the PCCH logical channel.

In some examples, the Paging message may be used for the notification of one or more UEs. An accessType field may indicate whether the Paging message is originated due to the PDU sessions from the non-3GPP access.

In some examples, an IE DownlinkConfigCommonSIB may provide common downlink parameters of a cell. A nrofPDCCH-MonitoringOccasionPerSSB-InPO field may indicate the number of PDCCH monitoring occasions corresponding to an SSB within a Paging Occasion. A pcch-Config may indicate the paging related configuration. A defaultPagingCycle field may indicate a default paging cycle. A firstPDCCH-MonitoringOccasionOfPO field may point out the first PDCCH monitoring occasion for paging of each PO of the paging frame (PF). A nAndPagingFrameOffset field may be used to derive the number of total paging frames in paging cycle T (corresponding to parameter N and paging frame offset. A field ns may indicate number of paging occasions per paging frame.

In some examples, the IE PDCCH-ConfigCommon may be used to configure cell specific PDCCH parameters provided in SIB as well as in dedicated signaling. A pagingSearchSpace field may indicate an ID of the Search space for paging.

In some examples, short Messages may be transmitted on PDCCH using P-RNTI with or without associated Paging message using Short Message field in DCI format 1_0.

In some examples, a UE may camp on a cell in RRC_IDLE state and RRC_INACTIVE state if the network needs to send a message or deliver data to the registered UE, it knows (in most cases) the set of tracking areas (in RRC_IDLE state) or RAN notification area (RNA) (in RRC_INACTIVE state) in which the UE is camped. It can then send a “paging” message for the UE on the control channels of all the cells in the corresponding set of areas. The UE may then receive the paging message and may respond.

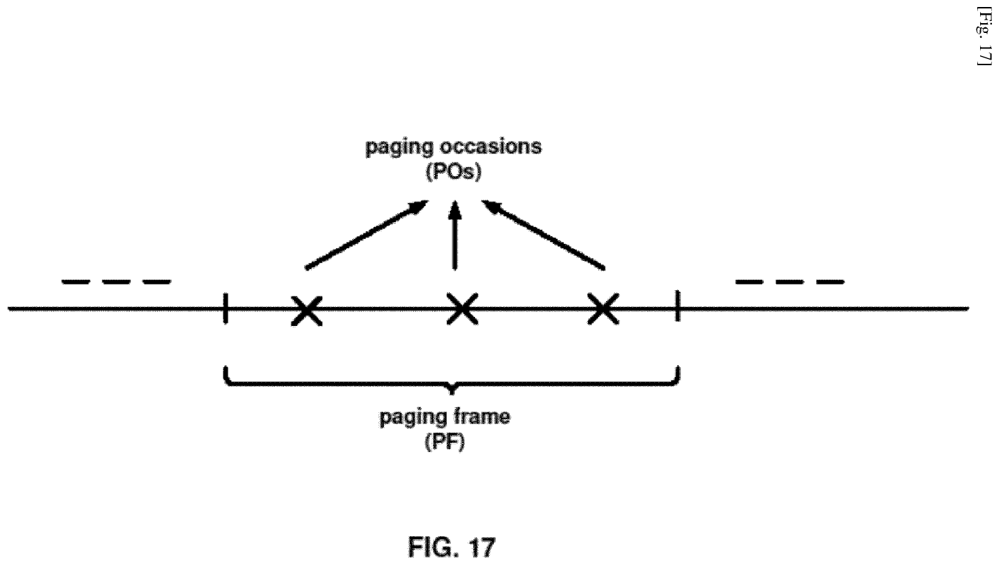

In some examples, The UE may use Discontinuous Reception (DRX) in RRC_IDLE and RRC_INACTIVE state in order to reduce power consumption. The UE may monitor one paging occasion (PO) per DRX cycle. A PO may be a set of PDCCH monitoring occasions and may consist of multiple time slots (e.g. subframe or OFDM symbol) where paging DCI may be sent. One Paging Frame (PF) may be one Radio Frame and may contain one or multiple PO(s) or starting point of a PO An example is shown in FIG. 17.

In some examples, in multi-beam operations, the UE may assume that the same paging message and the same Short Message are repeated in all transmitted beams and thus the selection of the beam(s) for the reception of the paging message and Short Message may be up to UE implementation. The paging message may be same for both RAN initiated paging and CN initiated paging.

In some examples, the UE may initiate RRC Connection Resume procedure upon receiving RAN initiated paging. If the UE receives a CN initiated paging in RRC_INACTIVE state, the UE may move to RRC_IDLE and informs NAS.

In some examples, the PF and PO for paging may be determined by the following formulae:
SFN for the PF is determined by: (SFN+PF_offset) mod T=(T div N)*(UE_ID mod N)
Index (i_s), indicating the index of the PO is determined by: i_s=floor (UE_ID/N) mod Ns

In some examples, the PDCCH monitoring occasions for paging may be determined according to pagingSearchSpace and firstPDCCH-MonitoringOccasionOfPO and nrofPDCCH-MonitoringOccasionPerSSB-InPO if configured. When SearchSpaceId=0 is configured for pagingSearchSpace, the PDCCH monitoring occasions for paging may be same as for RMSI.

In some examples, when SearchSpaceId=0 is configured for pagingSearchSpace, Ns may be either 1 or 2. For Ns=1, there may be only one PO which may start from the first PDCCH monitoring occasion for paging in the PF. For Ns=2, PO may be either in the first half frame (i_s=0) or the second half frame (i_s=1) of the PF.

In some examples, when SearchSpaceId other than 0 is configured for pagingSearchSpace, the UE monitors the (i_s+1)th PO. A PO may be a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]th PDCCH monitoring occasion for paging in the PO may correspond to the Kth transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) may be sequentially numbered from zero starting from the first PDCCH monitoring occasion for paging in the PF. When firstPDCCH-MonitoringOccasionOfPO is present, the starting PDCCH monitoring occasion number of (i_s+1)th PO may be the (i_s+1)th value of the firstPDCCH-MonitoringOccasionOfPO parameter; otherwise, it may be equal to i_s*S*X. If X>1, when the UE detects a PDCCH transmission addressed to P-RNTI within its PO, the UE may not be required to monitor the subsequent PDCCH monitoring occasions for this PO.

In some examples, a PO associated with a PF may start in the PF or after the PF. In some examples, the PDCCH monitoring occasions for a PO may span multiple radio frames. When SearchSpaceId other than 0 is configured for paging-SearchSpace the PDCCH monitoring occasions for a PO may span multiple periods of the paging search space.

In some examples, the following parameters may be used for the calculation of PF and i_s above:
T: DRX cycle of the UE (T may be determined by the shortest of the UE specific DRX value(s), if configured by RRC and/or upper layers, and a default DRX value broadcast in system information. In RRC_IDLE state, if UE specific DRX is not configured by upper layers, the default value may be applied.
N: number of total paging frames in T
Ns: number of paging occasions for a PF
PF_offset: offset used for PF determination
UE_ID: 5G-S-TMSI mod 1024

In some examples, the parameters Ns, nAndPagingFrameOffset, nrofPDCCH-MonitoringOccasionPerSSB-InPO, and the length of default DRX Cycle may be signaled in SIB1. The values of N and PF_offset may be derived from the parameter nAndPagingFrameOffset. The parameter first-PDCCH-MonitoringOccasionOfPO may be signaled in SIB1 for paging in initial DL BWP. For paging in a DL BWP other than the initial DL BWP, the parameter first-PDCCH-MonitoringOccasionOfPO may be signaled in the corresponding BWP configuration.

In some examples, if the UE has no 5G-S-TMSI, for instance when the UE has not yet registered onto the network, the UE may use as default identity UE_ID=0 in the PF and i_s formulas above. In some examples, the 5G-S-TMSI may be a 48 bit long bit string. 5G-S-TMSI in the formulae above may be interpreted as a binary number where the left most bit represents the most significant bit.

In some examples, an RRC Release procedure may be used: to release the RRC connection, which may include the release of the established radio bearers as well as all radio resources; or to suspend the RRC connection if SRB2 and at least one DRB or, for IAB, SRB2, are setup, which includes the suspension of the established radio bearers.

In some examples, the network may initiates the RRC connection release procedure to transit a UE in RRC_CONNECTED to RRC_IDLE; or to transit a UE in RRC_CONNECTED to RRC_INACTIVE if SRB2 and at least one DRB or, for IAB, SRB2, is setup in RRC_CONNECTED; or to transit a UE in RRC_INACTIVE back to RRC_INACTIVE when the UE tries to resume; or to transit a UE in RRC_INACTIVE to RRC_IDLE when the UE tries to resume. In some examples, the procedure may also be used to release and redirect a UE to another frequency.

In some examples, an RRC connection release requested by upper layers may be used to release the RRC connection. Access to the current PCell may be barred as a result of this procedure. In some examples, the UE may initiate the procedure when upper layers request the release of the RRC connection.

In some examples, an RRCRelease message may be used to command the release of an RRC connection or the suspension of the RRC connection. The RRC release message may comprise a suspendConfig may indicating configuration for the RRC_INACTIVE state.

In some examples, MBS transmission may support some form of common control, e.g. paging/notification signaling, to inform UEs in all RRC states about MBS configurations and session scheduling changes. In some examples, such MBS related signaling and data may support beamforming and beam sweeping. In some examples, for RRC_IDLE/RRC_INACTIVE UEs, beam sweeping may be supported for group-common PDCCH/PDSCH. Example embodiments enable targeted MBS Notification signaling design to avoid unnecessary system overhead and UE processing by non-MBS UEs.

In some examples, the MBS architecture may be based on single-cell point-to-multipoint (PTM) architecture and without use of wide area single frequency network (SFN).

In some examples, delivering MBS to UEs in all RRC states may require some broadcast and common control signaling to provide UEs with MBS configuration and session scheduling information. Such signaling may use a combination of broadcast messages (e.g., SIBs) and MCCH signaling. For example, a SIB message may be broadcast to provide singe-cell point-to-multipoint radio configuration including how to find SC-MCCH and PDCCH/SC-N-RNTI may be used to send notification for MCCH changes.

In some examples, MBS services may have widely different set of traffic models and use cases including broadcast and multicast services with different group sizes, periodicity and reliability requirements. The notification signaling design may take into account flexibility such as need for beamforming/beam sweeping of UE's bandwidth parts variations across UEs and on demand delivery of SIBs. The MBS common notification signaling may take into account availability of such signaling information to all UEs including those in Idle and Inactive States. In some examples, the delivery of MBS common notification signaling may support beam sweeping and beamforming.

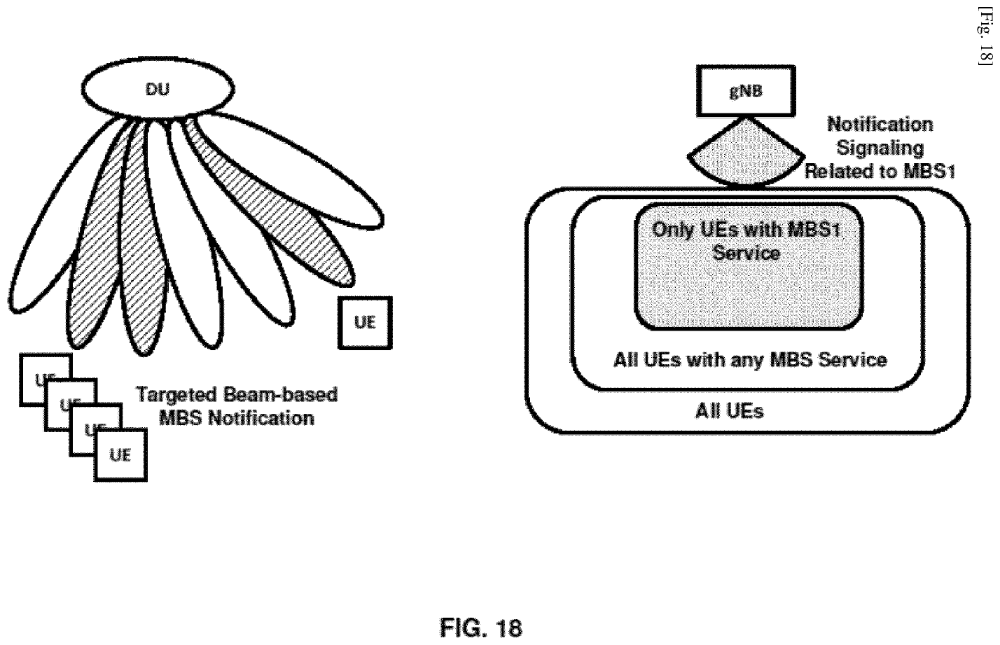

In some examples as shown in FIG. 18, with beam sweeping the MBS related notification for all concurrent MBS services may be repeated across many beams. Example embodiments may provide optimization to limit sending such notification only in cells/beams which cover MBS users. In some examples, MBS notification may support targeted transmission of MBS notification only within cells and beams which cover UEs with associated MBS services. In some examples, the notification signaling may take into account that there may be multiple concurrent MBS services with different set of member UEs and session periodicity/duration and traffic/QoS models.

In some examples, the RAN may offer multiple, potentially concurrent, MBS services with overlapping sessions each associated with a different identifier, e.g. G-RNTI, in the RAN and that not all UE may be interested in or are members of all multicast groups. In some examples, the MBS notification signaling may be targeted to multicast group so it may minimize unnecessary UE processing for users who are not part of target multicast group. In some examples, the MBS notification for an MBS service may be designed to avoid or minimize UE processing and power saving impact for UEs that are members of corresponding MBS group.

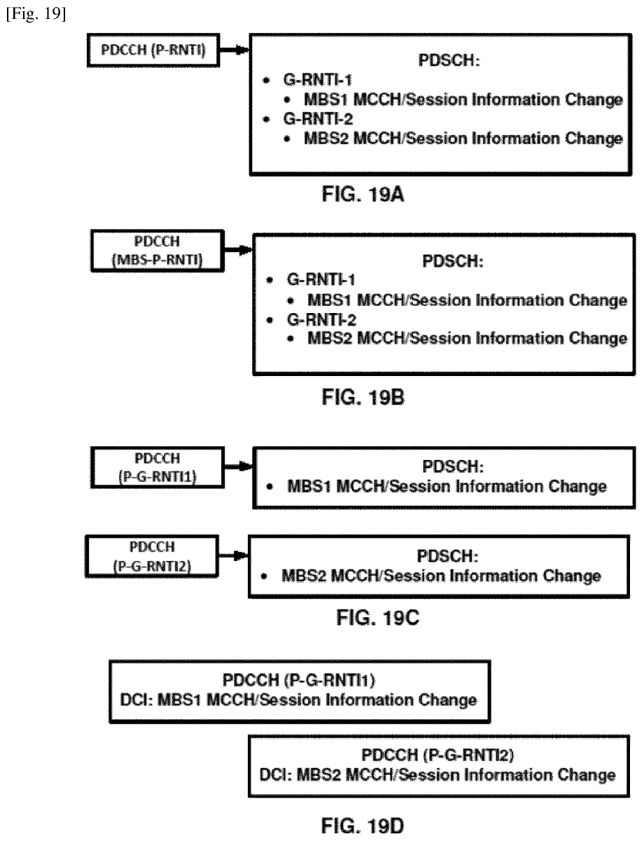

Example embodiments for notification signaling are shown in FIG. 19A-FIG. 19D.

In some example embodiments as shown in FIG. 19A, the notification signaling may use a generic paging notification to indicate SIB update, where SIB may contain MBS/MCCH information for all MBS services. A common MBS-N-RNTI may be used to send a notification for any MCCH change for any MBS service. With this approach, all UEs including those not belonging to any MBS groups may also attempt to find and decode the paging messages.

In some example embodiments as shown in FIG. 19B, the notification signaling may use an MBS specific paging RNTI, e.g. MBS-P-RNTI which may only page UEs with some MBS service. The notification information for all MBS services, each associated with a G-RNTI, e.g. MCCH changes or MBS session start time, e.g. System Frame Number may be included in the paging message. The UEs which may not be part of any MBS session may not receive and process the notification signaling and may not be impacted from power saving perspective. The UEs which may be part of any MBS group even those to which notification may not apply may detect and process the signaling message.

In some example embodiments as shown in FIG. 19C, the notification signaling may use generic MBS notification DCI with CRC masked with MBS-P-RNTI and may include the G-RNTI and Notification Information e.g. start time, in the DCI itself. With some payload optimization multiple G-RNTI and Notification Information may fit in the same DCI. With this approach, extra paging message decoding may be avoided and may still involve UEs processing notifications in the DCI which may not apply to their target MBS service.

In some example embodiments as shown in FIG. 19D, the notification signaling may use a notification RNTI for each MBS service with the same G-RNTI. Only UEs which may be members of a MBS group may monitor for the associated Group paging RNTI (G-P-RNTI). In this case, more group P-RNTI may be configured and a UE may monitor multiple such notifications, one for each MBS group that it is a member of. With this approach only UEs which are members of an MBS group may receive and process the PDCCHs carrying MBS session notification.

In RRC Idle/Inactive states, MBS notification signaling may be via paging. The existing paging mechanisms for UEs in RRC Idle/Inactive states result in a large overhead and increased power consumption for UEs that are not interested in MBS services. Example embodiments enhance the paging mechanisms for MBS notification signaling.

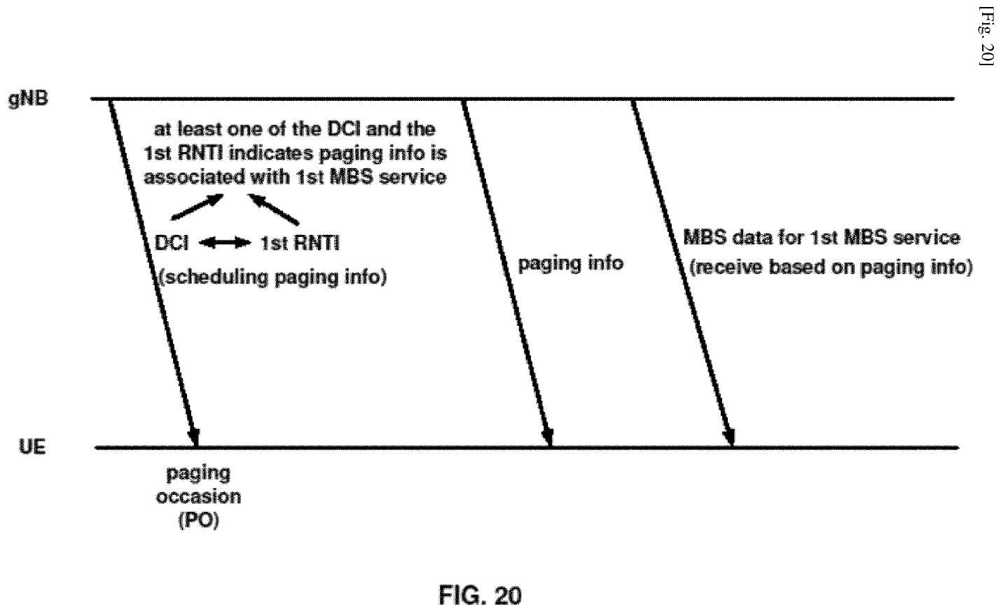

In an example embodiment as shown in FIG. 20, a UE may be in a first RRC state (e.g., in an RRC Idle state or an RRC Inactive state). In some examples, the UE may be in one of the RRC Inactive state and the RRC Idle state. The UE may transition from an RRC Connected state to the RRC Idle state or from the RRC connected state to the RRC Inactive state based on a RRC Connection release procedure, e.g., in response to receiving an RRC release message. For example, the UE may transition from an RRC Connected state to the RRC Inactive state based on an RRC suspend procedure, e.g., in response to receiving an RRC release message comprising a suspendconfig IE, wherein the suspendconfig IE indicates transitioning, by the UE, from the RRC connected state to the RRC inactive state.

The UE may monitor a downlink control channel (e.g., PDCCH), at paging occasions (POs), for receiving downlink control information associated with paging. The downlink control information may be associated with paging when the downlink control information is used for scheduling paging information. The monitoring (e.g., the timing of the monitoring) at the paging occasions may be based on a discontinuous reception (DRX) procedure. In some examples, the DRX procedure for monitoring the paging occasions may be according to an idle/inactive state DRX procedure. In some examples, the idle/inactive state DRX procedure may be used when the UE is in the idle state or the inactive state and may be different from a connected state DRX procedure that the UE may use wen the UE is in an RRC connected state. The DRX procedure may control monitoring a control channel for specific RNTI(s) used for scheduling paging information and/or scheduling information associated with MBS notification signaling. The UE may determine the paging occasions (POs) based on the DRX procedure. The determining the paging occasions may be based on determining paging frames (PFs) wherein a PF may comprise one or more POs. The determining the PF and/or POs may be based on a UE identifier (e.g., a temporary mobile subscription identity (TMSI) of the UE). The determining the PF and/or POs may be based on other parameters that may be broadcast and/or configured for the UE (e.g., included in an RRC release message). The one or more other parameters may comprise a DRX cycle that may be indicated to the UE based on system information broadcast to the UE via a broadcast message.

The UE may receive a DCI, in response to the monitoring the control channel in a paging occasion based on the DRX procedure. The DCI may comprise scheduling information for the paging information and/or scheduling information associated with MBS notification signaling (e.g., scheduling information for scheduling MBS notification signaling). In some examples, the paging information may comprise notification signaling for one or more MBS services comprising a first MBS service. The notification signaling associated with each of the one or more MBS services may comprise an MBS service-specific RNTI (e.g., G-RNTI) for scheduling MBS data associated with the MBS service, change such as control channel (e.g., multicast control channel (MCCH)) change information, an MBS session start time, etc. The MBS session start time may be based on a system frame number (SFN), e.g., a first SFN for a start time of an MBS service.

The DCI may be associated with (e.g., a CRC field of the DCI may be scrambled by) a first RNTI. In some examples, the first RNTI may have a pre-determined value. In some examples, the UE may receive the first RNTI via an RRC message such as via an RRC release message. For example, the RRC release message (or a suspendconfig IE of the RRC release message) may indicate transitioning from the RRC connected state to an RRC Inactive state and the suspendconfig IE may comprise a first parameter/field indicating the first RNTI.

In example embodiments, the first RNTI, associated with the DCI and/or the content of the DCI (e.g., value(s) of field(s) of the DCI) and/or the CORESET/search space that the DCI is received may indicate that the paging information scheduled by the DCI is associated with a first MBS service. In some examples, the UE may monitor the control channel (at the paging occasions determined based on the DRX procedure) based on the UE being interested in and/or configured with and/or belonging to an MBS group comprising the first MBS service. A UE may not be interested in the first MBS service, for example based on the UE not being capable of or not being configured with reception of any MBS services or not being configured with reception of the data of the first MBS service or determining that the first MBS service is not of interest based MBS service indications by network (e.g., according to G-RNTIs or other service identifiers of the first MBS service that are for example broadcast). In some examples, the UE may process the TB scheduled by the DCI, received via a downlink data channel (e.g., PDSCH) and comprising the paging information based on the UE being interested in and/or configured with and/or belonging to an MBS group comprising the first MBS service. In some example, the first RNTI, associated with the DCI and/or the content of the DCI (e.g., value(s) of field(s) of the DCI) and/or the CORESET/search space that the DCI is received may indicate that the paging information scheduled by the DCI is associated with a plurality (e.g., a group) of MBS services comprising the first MBS service. In some examples, the UE may monitor the control channel (at the paging occasions determined based on the DRX procedure) based on the UE being interested in and/or configured with and/or belonging to an MBS group comprising the plurality/group of the MBS services. In some examples, the UE may process the TB scheduled by the DCI and comprising the paging information based on the UE being interested in and/or configured with and/or belonging to an MBS group comprising the plurality/group of the MBS services. In some example, the first RNTI, associated with the DCI and/or the content of the DCI (e.g., value(s) of field(s) of the DCI) and/or the CORESET/search space that the DCI is received may indicate that the paging information scheduled by the DCI is associated with all of the MBS services. In some examples the field(s) of the DCI may comprise a first field indicating a service-specific radio network temporary identifier (RNTI) (e.g., G-RNTI) associated with the first MBS service. In some examples, there may be a mapping between MBS services or groups of MBS services and RNTIs. For example, there may be a mapping between the first RNTI and the first MBS service. In some examples, the mapping between the MBS services and/or the groups of the MBS services and the RNTI(s) may be preconfigured or may be configured, e.g., by an RRC message (e.g., in an RRC release message). For example, the RRC release message may comprise one or more IEs indicating the mappings between the MBS services and/or the groups of the MBS services and the RNTI(s).

In some examples, the UE may monitor the control channel (at the paging occasions determined based on the DRX procedure) based on the UE being interested in and/or configured with and/or any of the MBS services. In some examples, the UE may process the TB scheduled by the DCI and comprising the paging information based on the UE being interested in and/or configured with and/or any of the MBS services. The wireless device may receive the MBS data based on the paging information scheduled by the DCI.

The paging information received by the UE may comprise paging records for each UE that is paged. The paging records may be included in a paging message. The paging record for a UE may comprise an identifier of the UE. In some examples, the identifier of the UE may be the UE TMSI. In some examples, the identifier of the UE may be an RNTI received via an RRC message (e.g., an RRC release message, etc.).

In an embodiment, a user equipment (UE) may receive a downlink control information (DCI) associated with a first radio network temporary identifier (RNTI) and used for scheduling paging information. At least one of the first RNTI and the DCI may indicate that the paging information, scheduled by the DCI, is associated with a first MBS service. The UE may receive MBS data based on the paging information.

In some embodiments, the user equipment (UE) may be in one of a radio resource control (RRC) idle state and an RRC inactive state.

In some embodiments, the UE may monitor a downlink control channel for the first radio network temporary identifier (RNTI) based on the user equipment (UE) being interested in data associated with the first multicast and broadcast services (MBS) service.

In some embodiments, the UE may process a transport block (TB), scheduled by the downlink control information (DCI) and comprising the paging information, based on the user equipment (UE) being interested in data associated with the first multicast and broadcast services (MBS) service.

In some embodiments, the first radio network temporary identifier (RNTI) may be associated with a plurality of multicast and broadcast services (MBS) services comprising the first MBS service. In some embodiments, the paging information may comprise notification information associated with each of the plurality of the multicast and broadcast services (MBS) services.

In some embodiments, the notification information associated with each of the plurality of the multicast and broadcast services (MBS) services comprise one or more of: an MBS service-specific radio network temporary radio network identifier (RNTI) for scheduling MBS data associated with an MBS service; control channel change information; and a multicast and broadcast services (MBS) session start time. In some embodiments, the multicast and broadcast services (MBS) session start time may be based on a system frame number.

In some embodiments, the first radio network temporary identifier (RNTI) may be associated with all of multicast and broadcast services (MBS) services.

In some embodiments, the first radio network temporary identifier (RNTI) may be a predetermined value.

In some embodiments, the UE may receive a radio resource control (RRC) release message comprising a first parameter indicating the first radio network temporary identifier (RNTI), wherein the RRC release message may indicate transition of the user equipment (UE) from an RRC connected state to an RRC idle state.

In some embodiments, the UE may receive a radio resource control (RRC) release message comprising a suspendconfig information element (IE) comprising a first parameter indicating the first radio network temporary identifier (RNTI), wherein the RRC release message indicate transition of the user equipment (UE) from an RRC connected state to an RRC inactive state.

In some embodiments, the downlink control information (DCI) may define one or more values (e.g., a value of field) indicating the first multicast and broadcast services (MBS) service. In some embodiments, the value of the field may indicate an MBS service-specific radio network temporary identifier (RNTI) associated with the first multicast and broadcast services (MBS) service. In some embodiments, the first radio network temporary identifier (RNTI) may be associated with all of multicast and broadcast services (MBS) services. In some embodiments, the UE may process a transport block (TB), scheduled by the downlink control information (DCI) and may comprise the paging information, based on the user equipment (UE) being interested in data associated with the first multicast and broadcast services (MBS) service indicated by the at least one of the first radio network temporary identifier (RNTI) and the downlink control information (DCI).

In some embodiments, the UE may monitor a downlink control channel for the first radio network temporary identifier (RNTI). Illustratively, the monitoring of the downlink control channel may be based on discontinuous reception (DRX) procedure. In some embodiments, the discontinuous reception (DRX) procedure may comprise determining paging occasions; and the monitoring the paging channel may be at the paging occasions. In some examples, the UE may receive a broadcast message comprising one or more first parameters, wherein the determining the paging occasions may be based on the one or more first parameters. In some embodiments, the determining the paging occasions may be based on an identifier of the user equipment (UE).

In some embodiments, the identifier of the user equipment (UE) may be based on a temporary mobile subscription identity (TMSI). In some embodiments, the determining the paging occasions may be based on a discontinuous reception (DRX) cycle. In some embodiments, the discontinuous reception (DRX) cycle may be a predetermined number of frames. In some embodiments, the UE may receive a configuration parameter indicating the discontinuous reception (DRX) cycle. In some embodiments, the UE may receive broadcast system information. Illustratively, the discontinuous reception (DRX) cycle may be based on the broadcast system information. In some embodiments, the determining the paging occasions may be based on determining paging frames. In some examples, a paging frame, in the paging frames, may comprise a plurality of one or more first paging occasions of the paging occasions.

In some embodiments, the UE may receive a transport block (TB) via a physical downlink shared channel (PDSCH) comprising the paging information. In some examples, the downlink control information (DCI) may comprise scheduling information for receiving the TB. In some embodiments, the transport block (TB) may comprise a paging message comprising one or more paging records comprising a first paging record for the user equipment (UE). In some embodiments, the first paging record may define a first identifier of the user equipment (UE). In some embodiments, the first identifier may be a temporary mobile subscription identity (TMSI) associated with the user equipment (UE). In some embodiments, the UE may receive a radio resource control (RRC) release message defines a second radio network temporary identifier (RNTI) The first identifier may be the second RNTI. In some embodiments, the paging message may be a radio resource control (RRC) message.

In some embodiments, a mapping between the first radio network temporary identifier (RNTI) and the first multicast and broadcast services (MBS) service may be preconfigured.

In some embodiments, the UE may receive a radio resource control (RRC) release message comprising an information elements (IE) indicating the mapping between the first radio network temporary identifier (RNTI) and the first multicast and broadcast services (MBS) service.

The exemplary blocks and modules described in this disclosure with respect to the various example embodiments may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. Examples of the general-purpose processor include but are not limited to a microprocessor, any conventional processor, a controller, a microcontroller, or a state machine. In some examples, a processor may be implemented using a combination of devices (e.g., a combination of a DSP and a microprocessor, multiple microprocessors, one or more microprocessors in conjunction with a DSP core, or any other such configuration).

The functions described in this disclosure may be implemented in hardware, software executed by a processor, firmware, or any combination thereof. Instructions or code may be stored or transmitted on a computer-readable medium for implementation of the functions. Other examples for implementation of the functions disclosed herein are also within the scope of this disclosure. Implementation of the functions may be via physically co-located or distributed elements (e.g., at various positions), including being distributed such that portions of functions are implemented at different physical locations.

Computer-readable media includes but is not limited to non-transitory computer storage media. A non-transitory storage medium may be accessed by a general purpose or special purpose computer. Examples of non-transitory storage media include, but are not limited to, random access memory (RAM), read-only memory (ROM), electrically erasable programmable ROM (EEPROM), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable media.

As used in this disclosure, use of the term “or” in a list of items indicates an inclusive list. The list of items may be prefaced by a phrase such as “at least one of’ or “one or more of”. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open-ending. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

Clause 1. A method of paging for multicast and broadcast services (MBS) data transmission, comprising
receiving, by a user equipment (UE), downlink control information (DCI) associated with a first radio network temporary identifier (RNTI) and used for scheduling paging information, wherein at least one of the first RNTI and the DCI indicates that the paging information, scheduled by the DCI, is associated with a first MBS service; and
receiving MBS data based on the paging information.

Clause 2. The method of Clause 1, wherein the UE is in one of a radio resource control (RRC) idle state and an RRC inactive state.

Clause 3. The method of Clause 1, further comprising monitoring a downlink control channel for the first RNTI.

Clause 4. The method of Clause 1, further comprising processing a transport block (TB), scheduled by the DCI and comprising the paging information.

Clause 5. The method of Clause 1, wherein the first RNTI is associated with a plurality of MBS services comprising the first MBS service.

Clause 6. The method of Clause 5, wherein the paging information comprises notification information associated with each of the plurality of the MBS services.

Clause 7. The method of Clause 6, wherein the notification information associated with individual MBS services comprise one or more of:
an MBS service-specific radio network temporary radio network identifier (RNTI) for scheduling MBS data associated with an MBS service;
control channel change information; and a MBS session start time.

Clause 8. The method of Clause 7, wherein the MBS session start time is based on a system frame number.

Clause 9. The method of Clause 1, wherein, the first RNTI is associated with a plurality of MBS services.

Clause 10. The method of Clause 1, wherein the first RNTI is a predetermined value.

Clause 11. The method of Clause 1, further comprising receiving a RRC release message comprising a first parameter indicating the first RNTI, wherein the RRC release message indicates transition of the UE from an RRC connected state to an RRC idle state.

Clause 12. The method of Clause 1, further comprising receiving a RRC release message comprising an information element, the information element comprising a first parameter defining the first RNTI, wherein the RRC release message indicates transition of the UE from an RRC connected state to an RRC inactive state.

Clause 13. The method of Clause 1, wherein the DCI defines a value associated with the first MBS service.

Clause 14. The method of Clause 13, wherein the defined value corresponds to an MBS service-specific RNTI associated with the first MBS service.

Clause 15. The method of Clause 13, wherein, the first RNTI is associated with a plurality of MBS services.

Clause 16. The method of Clause 13, further comprising processing a transport block, scheduled by the DCI and comprising the paging information.

Clause 17. The method of Clause 1, further comprising monitoring a downlink control channel for the first RNTI, wherein the monitoring is based on discontinuous reception (DRX) procedure.

Clause 18. The method of Clause 17, wherein the DRX procedure includes a determination of paging occasions and wherein monitoring the downlink control channel includes monitoring the downlink control channel at the paging occasions.

Clause 19. The method of Clause 18, further comprising:
receiving a broadcast message comprising one or more first parameters; and
determining paging occasions based on the one or more first parameters.

Clause 20. The method of Clause 18, wherein the DRX procedure determines the paging occasions based on an identifier of the UE.

Clause 21. The method of Clause 18, wherein the identifier of the UE is based on a temporary mobile subscription identity (TMSI).

Clause 22. The method of Clause 18, wherein DRX procedure determines the paging occasions based on a DRX cycle.

Clause 23. The method of Clause 22, wherein the DRX cycle is a predetermined number of frames.

Clause 24. The method of Clause 22, further comprising receiving a configuration parameter indicating the DRX cycle.

Clause 25. The method of Clause 22, further comprising receiving broadcast system information, wherein the DRX cycle is based on the broadcast system information.

Clause 26. The method of Clause 18, wherein the DRX procedure determines the paging occasions based on determining paging frames, each of which comprising one or more first paging occasions of the paging occasions.

Clause 27. The method of Clause 1, further comprising receiving a transport block via a physical downlink shared channel (PDSCH) comprising the paging information, wherein the DCI comprises scheduling information for receiving a transport block.

Clause 28. The method of Clause 27, wherein the transport block comprises a paging message and wherein the paging message comprises one or more paging records that include a first paging record for the UE.

Clause 29. The method of Clause 28, wherein the first paging record comprises a first identifier of the UE.

Clause 30. The method of Clause 29, wherein the first identifier is a temporary mobile subscription identity (TMSI) associated with the UE.

Clause 31. The method of Clause 29, further comprising receiving a RRC message defines a second RNTI, wherein the first identifier corresponds to the second RNTI.

Clause 32. The method of Clause 28, wherein the paging message is a RRC message.

Clause 33. The method of Clause 1, wherein a mapping between the first RNTI and the first MBS service is preconfigured.

Clause 34. The method of Clause 1, further comprising receiving a RRC release message and wherein the RRC release message comprises an information element indicating the mapping between the first RNTI and the first MBS service.

Clause 35. A method of paging for multicast and broadcast services (MBS) data transmission, comprising
monitoring, by a user equipment (UE), a downlink control channel for a radio network temporary identifier (RNTI), wherein the UE corresponds to at least one of a first radio resource control (RRC) state or a second RRC state and wherein monitoring the DCI is based on a discontinuous reception (DRX) procedure;
receiving, by the UE, downlink control information (DCI) associated with the RNT and used for scheduling paging information, wherein at least one of the first RNTI and the DCI indicates that the paging information, scheduled by the DCI, is associated with a first MBS service; and
receiving MBS data based on the paging information.

Clause 36. The method of Clause 35, further comprising processing a transport block (TB), scheduled by the DCI and comprising the paging information.

Clause 37. The method of Clause 35, wherein the first RNTI is associated with a plurality of MBS services including the first MBS service.

Clause 38. The method of Clause 35, wherein the first RNTI is associated with a plurality of MBS services.

Clause 39. The method of Clause 35, further comprising receiving a RRC release message comprising a first parameter indicating the first RNTI, wherein the RRC release message indicates transition of the UE from the first RRC state to the second RRC state.

Clause 40. The method of Clause 38, wherein the second RRC state of the UE corresponds to one of a radio resource control (RRC) idle state and an RRC inactive state.

Clause 41. The method of Clause 35, wherein the DCI defines a value corresponding to an MBS service-specific RNTI associated with the first MBS service.

Clause 42. The method of Clause 35, wherein the DRX procedure includes a determination of paging occasions and wherein monitoring the downlink control channel includes monitoring the downlink control channel at the paging occasions.

Clause 43. The method of Clause 42, further comprising:
receiving a broadcast message comprising one or more first parameters; and
determining paging occasions based on the one or more first parameters.

Clause 44. The method of Clause 42, wherein the DRX procedure determines the paging occasions based on an identifier of the UE.

Clause 45. The method of Clause 42, wherein the identifier of the UE is based on a temporary mobile subscription identity (TMSI).

Clause 46. The method of Clause 42, wherein DRX procedure determines the paging occasions based on a DRX cycle.

Clause 47. The method of Clause 46, wherein the DRX cycle is a predetermined number of frames.

Clause 48. The method of Clause 46, further comprising receiving a configuration parameter indicating the DRX cycle.

Clause 49. The method of Clause 46, further comprising receiving broadcast system information, wherein the DRX cycle is based on the broadcast system information.

Clause 50. The method of Clause 35, further comprising receiving a transport block via a physical downlink shared channel (PDSCH) comprising the paging information, wherein the DCI comprises scheduling information for receiving the transport block.

Clause 51. An apparatus for utilization in wireless communications comprising:
an antenna for use in transmission of electromagnetic signals;
a memory for maintaining computer-readable code; and
a processor for executing the computer-readable code that causes the apparatus to:
receive downlink control information (DCI) associated with a first radio network temporary identifier (RNTI) and used for scheduling paging information, wherein at least one of the first RNTI and the DCI indicates that the paging information, scheduled by the DCI, is associated with a first MBS service; and receive MBS data based on the paging information.

Clause 52. The apparatus of Clause 51, wherein the UE is in one of a radio resource control (RRC) idle state and an RRC inactive state.

Clause 53. The apparatus of Clause 51, wherein the apparatus monitors a downlink control channel for the first RNTI.

Clause 54. The apparatus of Clause 51, wherein the apparatus processes a transport block (TB), scheduled by the DCI and comprising the paging information.

Clause 55. The apparatus of Clause 51, wherein the first RNTI is associated with a plurality of MBS services comprising the first MBS service.

Clause 56. The apparatus of Clause 55, wherein the paging information comprises notification information associated with each of the plurality of the MBS services.

Clause 57. The apparatus of Clause 56, wherein the notification information associated with individual MBS services comprise one or more of:
an MBS service-specific radio network temporary radio network identifier (RNTI) for scheduling MBS data associated with an MBS service;
control channel change information; and a MBS session start time.

Clause 58. The apparatus of Clause 57, wherein the MBS session start time is based on a system frame number.

Clause 59. The apparatus of Clause 51, wherein, the first RNTI is associated with a plurality of MBS services.

Clause 60. The apparatus of Clause 51, wherein the first RNTI is a predetermined value.

Clause 61. The apparatus of Clause 51, wherein the apparatus receives a RRC release message comprising a first parameter indicating the first RNTI, wherein the RRC release message indicates transition of the UE from an RRC connected state to an RRC idle state.

Clause 62. The apparatus of Clause 51, wherein the apparatus receives a RRC release message comprising an information element, the information element comprising a first parameter defining the first RNTI, wherein the RRC release message indicates transition of the UE from an RRC connected state to an RRC inactive state.

Clause 63. The apparatus of Clause 51, wherein the DCI defines a value associated with the first MBS service.

Clause 64. The apparatus of Clause 63, wherein the defined value corresponds to an MBS service-specific RNTI associated with the first MBS service.

Clause 65. The apparatus of Clause 63, wherein, the first RNTI is associated with a plurality of MBS services.

Clause 66. The apparatus of Clause 63, wherein the apparatus a transport block, scheduled by the DCI and comprising the paging information.

Clause 67. The apparatus of Clause 51, wherein the apparatus monitors a downlink control channel for the first RNTI based on discontinuous reception (DRX) procedure.

Clause 68. The apparatus of Clause 67, wherein the DRX procedure includes a determination of paging occasions and wherein monitoring the downlink control channel includes monitoring the downlink control channel at the paging occasions.

Clause 69. The apparatus of Clause 68, wherein the apparatus:
receives a broadcast message comprising one or more first parameters; and
determines paging occasions based on the one or more first parameters.

Clause 70. The apparatus of Clause 68, wherein the DRX procedure determines the paging occasions based on an identifier of the UE.

Clause 71. The apparatus of Clause 68, wherein the identifier of the UE is based on a temporary mobile subscription identity (TMSI).

Clause 72. The apparatus of Clause 68, wherein DRX procedure determines the paging occasions based on a DRX cycle.

Clause 73. The apparatus of Clause 72, wherein the DRX cycle is a predetermined number of frames.

Clause 74. The apparatus of Clause 72, wherein the apparatus receives a configuration parameter indicating the DRX cycle.

Clause 75. The apparatus of Clause 72, wherein the apparatus receives broadcast system information, wherein the DRX cycle is based on the broadcast system information.

Clause 76. The apparatus of Clause 68, wherein the DRX procedure determines the paging occasions based on determining paging frames, each of which comprising one or more first paging occasions of the paging occasions.

Clause 77. The apparatus of Clause 53, further comprising receiving a transport block via a physical downlink shared channel (PDSCH) comprising the paging information, wherein the DCI comprises scheduling information for receiving a transport block.

Clause 78. The apparatus of Clause 77, wherein the transport block comprises a paging message and wherein the paging message comprises one or more paging records that include a first paging record for the UE.

Clause 79. The apparatus of Clause 78, wherein the first paging record comprises a first identifier of the UE.

Clause 80. The apparatus of Clause 79, wherein the first identifier is a temporary mobile subscription identity (TMSI) associated with the UE.

Clause 81. The apparatus of Clause 79, wherein the apparatus receives a RRC message comprising a second RNTI, wherein the first identifier is the second RNTI.

Clause 82. The apparatus of Clause 81, wherein the paging message is a RRC message.

Clause 83. The apparatus of Clause 51, wherein a mapping between the first RNTI and the first MBS service is preconfigured.

Clause 84. The apparatus of Clause 51, wherein the apparatus receives a RRC release message and wherein the RRC release message comprises an information element indicating the mapping between the first RNTI and the first MBS service.

Clause 85. An apparatus for utilization in wireless communications comprising: an antenna for use in transmission of electromagnetic signals;
a memory for maintaining computer-readable code; and
a processor for executing the computer-readable code that causes the apparatus to:
monitor a downlink control channel for a radio network temporary identifier (RNTI), wherein the UE corresponds to at least one of a first radio resource control (RRC) state or a second RRC state and wherein monitoring the DCI is based on a discontinuous reception (DRX) procedure;
receive downlink control information (DCI) associated with the RNT and used for scheduling paging information, wherein at least one of the first RNTI and the DCI indicates that the paging information, scheduled by the DCI, is associated with a first MBS service; and
receive MBS data based on the paging information.

Clause 86. The apparatus of Clause 85, wherein the apparatus processes a transport block, scheduled by the DCI and comprising the paging information.

Clause 87. The apparatus of Clause 85, wherein the first RNTI is associated with a plurality of MBS services including the first MBS service.

Clause 88. The apparatus of Clause 85, wherein the paging information comprises notification information associated with each of the plurality of the MBS services.

Clause 89. The apparatus of Clause 85, wherein, the first RNTI is associated with a plurality of MBS services.

Clause 90. The apparatus of Clause 85, wherein the apparatus receives a RRC release message comprising a first parameter indicating the first RNTI, wherein the RRC release message indicates transition of the UE from the first RRC state to the second RRC state.

Clause 91. The apparatus of Clause 90, wherein the second RRC state of the UE corresponds to one of a radio resource control (RRC) idle state and an RRC inactive state.

Clause 92. The apparatus of Clause 85, wherein the DCI defines a value corresponding to an MBS service-specific RNTI associated with the first MBS service.

Clause 93. The apparatus of Clause 85, wherein the DRX procedure includes a determination of paging occasions and wherein monitoring the downlink control channel includes monitoring the downlink control channel at the paging occasions.

Clause 94. The apparatus of Clause 93, wherein the apparatus:
receives a broadcast message comprising one or more first parameters; and
determines paging occasions based on the one or more first parameters.

Clause 95. The apparatus of Clause 42, wherein the DRX procedure determines the paging occasions based on an identifier of the UE.

Clause 96. The apparatus of Clause 42, wherein the identifier of the UE is based on a temporary mobile subscription identity (TMSI).

Clause 97. The apparatus of Clause 42, wherein DRX procedure determines the paging occasions based on a DRX cycle.

Clause 98. The apparatus of Clause 46, wherein the DRX cycle is a predetermined number of frames.

Clause 99. The apparatus of Clause 97, wherein the apparatus receives a configuration parameter indicating the DRX cycle.

Clause 100. The apparatus of Clause 97, further comprising receiving broadcast system information, wherein the DRX cycle is based on the broadcast system information.

Clause 101. The apparatus of Clause 85, wherein the apparatus receives a transport block via a physical downlink shared channel (PDSCH) comprising the paging information, wherein the DCI comprises scheduling information for receiving the transport block.

Clause 102. A method of paging for multicast and broadcast services (MBS) data transmission, comprising
transmitting, by a base station, downlink control information (DCI) associated with a first radio network temporary identifier (RNTI) and used for scheduling paging information, wherein at least one of the first RNTI and the DCI indicates that the paging information, scheduled by the DCI, is associated with a first MBS service; and
transmitting MBS data based on the paging information.

Clause 103. A method of paging for multicast and broadcast services (MBS) data transmission, comprising:
transmitting, by a base station, downlink control information (DCI) associated with the RNT and used for scheduling paging information, wherein at least one of the first radio network temporary identifier (RNTI) and the DCI indicates that the paging information, scheduled by the DCI, is associated with a first MBS service; and
transmitting MBS data based on the paging information,
wherein the DCI is received by a user equipment (UE) monitoring a downlink control channel for the RNTI, wherein the UE corresponds to at least one of a first radio resource control (RRC) state or a second RRC state and wherein monitoring the DCI is based on a discontinuous reception (DRX) procedure.

This application claims the benefit of U.S. Provisional Application No. 63/122,643, entitled “TARGETED MULTICAST BROADCAST SERVICES (MBS) NOTIFICATION SIGNALING”, and filed on Dec. 8, 2020. U.S. Provisional Application No. 63/122,643 is incorporated by reference herein.

1-40. (canceled)

41. A method of paging for multicast and broadcast services (MBS) data transmission, comprising
receiving, by a user equipment (UE), downlink control information (DCI) associated with a first radio network temporary identifier (RNTI) and used for scheduling paging information, wherein at least one of the first RNTI and the DCI indicates that the paging information, scheduled by the DCI, is associated with a first MBS service; and
receiving MBS data based on the paging information.

42. The method of claim 41, wherein the UE is in one of a radio resource control (RRC) idle state and an RRC inactive state.

43. The method of claim 41, further comprising monitoring a downlink control channel for the first RNTI.

44. The method of claim 41, further comprising processing a transport block (TB), scheduled by the DCI and comprising the paging information.

45. The method of claim 44, wherein the first RNTI is associated with a plurality of MBS services comprising the first MBS service.

46. The method of claim 45, wherein the paging information comprises notification information associated with each of the plurality of the MBS services.

47. The method of claim 46, wherein the notification information associated with individual MBS services comprise one or more of:
an MBS service-specific radio network temporary radio network identifier (RNTI) for scheduling MBS data associated with an MBS service;
control channel change information; and
a MBS session start time.

48. The method of claim 47, wherein the MBS session start time is based on a system frame number.

49. The method of claim 41, wherein, the first RNTI is associated with a plurality of MBS services.

50. The method of claim 41, wherein the first RNTI is a predetermined value.

51. The method of claim 41, further comprising receiving a RRC release message comprising a first parameter indicating the first RNTI, wherein the RRC release message indicates transition of the UE from an RRC connected state to an RRC idle state.

52. The method of claim 41, further comprising receiving a RRC release message comprising an information element, the information element comprising a first parameter defining the first RNTI, wherein the RRC release message indicates transition of the UE from an RRC connected state to an RRC inactive state.

53. The method of claim 41, wherein the DCI defines a value associated with the first MBS service.

54. The method of claim 53, wherein the defined value corresponds to an MBS service-specific RNTI associated with the first MBS service.

55. The method of claim 53, wherein, the first RNTI is associated with a plurality of MBS services.

56. The method of claim 53, further comprising processing a transport block, scheduled by the DCI and comprising the paging information.

57. The method of claim 41, further comprising monitoring a downlink control channel for the first RNTI, wherein the monitoring is based on discontinuous reception (DRX) procedure.

58. The method of claim 57, wherein the DRX procedure includes a determination of paging occasions and wherein monitoring the downlink control channel includes monitoring the downlink control channel at the paging occasions.

59. A method of paging for multicast and broadcast services (MBS) data transmission, comprising:
monitoring, by a user equipment (UE), a downlink control channel for a radio network temporary identifier (RNTI), wherein the UE corresponds to at least one of a first radio resource control (RRC) state or a second RRC state and wherein monitoring the DCI is based on a discontinuous reception (DRX) procedure;
receiving, by the UE, downlink control information (DCI) associated with the RNT and used for scheduling paging information, wherein at least one of the first RNTI and the DCI indicates that the paging information, scheduled by the DCI, is associated with a first MBS service; and
receiving MBS data based on the paging information.

60. A method of paging for multicast and broadcast services (MBS) data transmission, comprising
transmitting, by a base station, downlink control information (DCI) associated with a first radio network temporary identifier (RNTI) and used for scheduling paging information, wherein at least one of the first RNTI and the DCI indicates that the paging information, scheduled by the DCI, is associated with a first MBS service; and
transmitting MBS data based on the paging information.
